(19) United States
(12) Patent Application Publication
(10) Pub. No.: US 2022/0206912 A1
(43) Pub. Date: Jun. 30, 2022

(54) SYSTEM FOR DETERMINING AUDIO AND VIDEO OUTPUT ASSOCIATED WITH A TEST DEVICE

(71) Applicant: HEADSPIN, INC., Palo Alto, CA (US)

(72) Inventors: SEVERIN SMITH, TORONTO (CA); THOMAS HOBSON, TORONTO (CA); ELIAS PSCHERNIG, PICKERINGTON, OH (US); BRIEN COLWELL, REDWOOD CITY, CA (US)

(21) Appl. No.: 17/139,350

(22) Filed: Dec. 31, 2020

(51) Int. Cl. G06F 11/22; G06F 11/263

(52) U.S. Cl. CPC G06F 11/2221; G06F 11/263

(57) ABSTRACT

An enclosure for testing performance of an application contains one or more devices. A first device being tested presents output using a display or a speaker. A camera or microphone, which may be associated with a second device in the enclosure, acquires information regarding the output, such as by acquiring data representing the display output of the first device using a camera. An interface presenting information regarding the performance of the application includes information determined using the camera or microphone, which may be useful when the first device is unable to directly capture the output that is presented. In other cases, a second device in the enclosure may provide a display output or an audio output, and the first device may receive the output using a camera or microphone, enabling the performance of the application relating to receipt of input by the first device to be tested.

### BACKGROUND

An application may function differently at different locations, on different devices, and under different network conditions. In some cases, these factors may affect the presentation of images, video content, or audio. Acquiring information about the characteristics of the output presented by a device may be useful to improve performance of the application.

### INCORPORATION BY REFERENCE

U.S. patent application Ser. No. 14/850,798, filed Sep. 10, 2015 and titled “System for Application Test”, now U.S. Pat. No. 9,681,318, is hereby incorporated by reference in its entirety.

U.S. application Ser. No. 15/425,757, filed Feb. 6, 2017 and titled “Mobile Device Point of Presence Infrastructure”, now U.S. Pat. No. 10,729,038, is hereby incorporated by reference in its entirety.

U.S. patent application Ser. No. 15/783,859, filed Oct. 13, 2017 and titled “System for Testing Using Remote Connectivity” is hereby incorporated by reference in its entirety.

U.S. patent application Ser. No. 16/593,847, filed Oct. 4, 2019 and titled “Secure Enclosure for Devices Used to Test Remote Connectivity” is hereby incorporated by reference in its entirety.

U.S. patent application Ser. No. 16/694,886, filed Nov. 25, 2019 and titled “System for Identifying Issues During Testing of Applications” is hereby incorporated by reference in its entirety.

U.S. patent application Ser. No. 16/056,797, filed Aug. 7, 2018 and titled “System for Controlling Transfer of Data to a Connected Device” is hereby incorporated by reference in its entirety.

U.S. patent application Ser. No. 16/297,380, filed Mar. 8, 2019 and titled “System to Determine Performance Based on Entropy Values” is hereby incorporated by reference in its entirety.

U.S. patent application Ser. No. 17/006,596, filed Aug. 28, 2020 and titled “Reference-Free System for Determining Quality of Video Data” is hereby incorporated by reference in its entirety.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A-1D depict an implementation of a system in which performance of an application may be tested using multiple devices within an enclosure.

FIG. 2 depicts an implementation of a system for testing performance of an application when using a device executing the application to acquire data regarding output presented by one or more other devices.

FIG. 3 depicts an implementation of a system for testing performance of an application when using a device executing the application to present output and acquiring data regarding the output using one or more other devices.

FIG. 4 depicts an implementation of a system for testing performance of an application when using a device executing the application to receive audio input and present an audio output in response to the audio input.

FIG. 5 depicts an implementation of a system for testing performance of an application when using a device executing the application to receive a control signal and cause a display device to present a display output in response to the control signal.

FIG. 6 depicts an implementation of a system for using a first device to determine data regarding performance of an application executed by a second device and using the second device to determine data regarding performance of an application executed by the first device.

FIG. 7 depicts an implementation of a system for using a single device within an enclosure to determine performance of an application executed by the device.

FIG. 8 is a block diagram illustrating an implementation of a system for determining data regarding performance of an application from multiple devices within an enclosure.

FIG. 9 is a diagram depicting an example implementation of an interface that may be generated based on data determined from devices in an enclosure.

FIG. 10 is a block diagram depicting an implementation of a computing device within the present disclosure.

FIG. 11 is a flow diagram illustrating an implementation of a method for determining data indicative of performance of an application.

FIG. 12 depicts an implementation of a system for testing applications that utilize network resources, in which various metrics, including characteristics of output presented by a test device (TD) or input received by the TD while executing an application, may be determined.

FIG. 13 is a diagram depicting an implementation of a control interface that may be accessed by a user to provide input to devices in an enclosure and receive output from the devices.

While implementations are described in this disclosure by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used in this disclosure are for organizational purposes only and are not meant to be used to limit the scope of the description or the claims. As used throughout this application, the word “may” is used in a permissive sense (i.e., meaning having the potential to) rather than the mandatory sense (i.e., meaning must). Similarly, the words “include”, “including”, and “includes” mean “including, but not limited to”.

### DETAILED DESCRIPTION

A computing device may provide various functions, some of which may be associated with execution of one or more applications. Computing devices may include, for example, smartphones, laptops, tablet computers, desktop computers, servers, embedded devices, wearable computing devices, appliances, computing devices associated with vehicles, set top box devices, smart televisions, network-enabled speakers, and so forth. Functions provided by such devices may include, without limitation, retrieval or transmission of data, presentation of data using a display device, acquisition of data using a camera, output of audio, acquisition of audio data using a microphone, processing of data, and so forth. For example, a smartphone executing an application may present a video using a display, and may present audio associated with the video using a speaker. As another example, a network-enabled speaker device executing a “smart assistant” application may receive audio data, such as voice commands, using a microphone, and may provide audio output in response to the received voice commands. As yet another example, a set top box device may receive control commands from another device and provide data to a display and one or more speakers for output.

The performance of an application executed by a device may be evaluated based on various characteristics, such as video quality, an amount of content that is presented, a frame rate, an amount of data that is transferred, memory use, processor use, and so forth. Applications may be tested to determine characteristics of an output that may indicate acceptable or unacceptable performance of the application. However, due to the large number of factors that may affect the performance of the application, determining the causes of poor performance or changes that may be made to a device or application to improve performance may be difficult. Additionally, some types of content may include private, sensitive, or confidential information for which presentation should be controlled to prevent acquisition of the information by unauthorized parties. Also, in some cases, some types of content, such as content associated with Digital Rights Management (DRM) protections, may be unable to be captured by a device that is presenting the content, preventing the analysis of the output when testing the performance of the application.

Described in this disclosure are systems for acquiring data regarding an output presented using a computing device in a secure manner, using one or more other devices, that may not be affected by performance issues associated with the device that is presenting the output, and that may not be affected by restrictions regarding the ability of the device to capture or transmit information associated with the output.

A test device (TD) and at least one other computing device may be placed in an enclosure. The enclosure may include locks or other security features for controlling access to the devices and to prevent unauthorized viewing of content presented by the devices. The enclosure may be formed from materials that permit the transmission and reception of network signals, such as cellular, Wi-Fi, and Bluetooth signals using the devices within the enclosure. For example, the enclosure may be formed primarily from steel, while one or more panels, such as the front and rear panels, may be formed from acetal plastic. In other implementations, one or more panels of the enclosure may be formed from wood, cork, rock, natural fibers, and so forth. Additionally, the enclosure may be formed from materials or may include features that limit transmission of light and sound from outside the enclosure to the interior, and from the interior to the outside of the enclosure. For example, the enclosure may include opaque materials, foam, rubber, or other materials that reduce the transmission of sound between the interior and exterior of the enclosure, gaskets for securing features and surfaces in a manner that limits transmission of light or sound around the features, baffles for reducing sound transmission positioned over fans or other openings to the exterior of the enclosure, and so forth. In some implementations, the enclosure may include mounts or other types of features for engaging one or more devices to a surface within the enclosure in a generally fixed position. In some implementations, the devices or the mounts may be moveable. For example, a first device may be positioned to properly align a display of the first device within a field of view of a camera of a second device. In some implementations, a device may be movable during testing of an application. For example, a mount on which a device is positioned may be associated with a motor, one or more servos, or other mechanisms that provide motive force to the mount or to the device. Continuing the example, a device may be moved during execution of an application to test one or more functions, such as an auto-focus feature of a device camera, detection of audio input by a microphone at different ranges or positions relative to a source of sound, and so forth.

In some implementations, the TD may be caused to present a visible output using a display. In other implementations, the TD may be caused to present an audio output using a speaker. In still other implementations, the output presented using the TD may include both visible and audio outputs. The output may be based on input data provided to the TD or stored in association with the TD. A second device within the enclosure may acquire data indicative of the output using a camera or microphone. For example, the display of the TD may be positioned within the field of view of a camera associated with a second device in the enclosure. As another example, the second device may be positioned relative to the first device such that data indicative of sound emitted from a speaker of the TD is able to be acquired using a microphone of the second device. Data from the first device regarding the output and data from the second device that is acquired using the camera or microphone may be used to generate an interface presenting information regarding performance of the application. For example, an interface may associate an indication of the input data that was used to produce the output with data regarding the output that was determined from the TD, and data from a second device that was acquired using a camera or microphone. In one implementation, the TD may be a set top box device that receives a command or other type of input data from a control device that may be located within the enclosure or external to the enclosure. In response to the command or other input data, the set top box device may provide data to one or more displays or speakers that are within the enclosure for presentation of an output. Another device in the enclosure may acquire data indicative of the output using one or more cameras or microphones. In some implementations, a third device in the enclosure may also include a camera or microphone and may acquire additional data from the TD. For example, the second device and third device may be positioned on opposite sides of the TD, a camera of the second device may acquire data indicative of the display of the TD, and a camera of the third device may acquire data indicative of one or more exterior features on the TD that are opposite the display, such as one or more LEDs. Information associated with the data acquired using the third device may also be included in the interface.

In other implementations, one or more other devices within the enclosure may be caused to present a visible or audio output, and the TD may use one or more cameras or microphones to acquire data associated with the output. For example, the TD may execute an application that uses a camera or microphone of the TD, and another device in the enclosure may present a video output within a field of view of the camera of the TD or an audio output that is detectable using a microphone of the TD. An interface may be generated that presents an indication of the input data, data regarding the output that is determined from the second device, and data from the TD that was acquired using the camera or microphone. In one implementation, the TD may include a networked speaker device executing a smart assistant application, and the second device may provide an audio output that includes a voice command. A microphone associated with the TD may acquire data indicative of the audio output, and the TD may then generate an output in response to the acquired data. One or more microphones associated with the second device or another device in the enclosure may determine audio outputs provided by the TD, while one or more cameras associated with the second device or another device in the enclosure may determine visible outputs such as actuation of LEDs or other components of the TD. As another example, a third device may be positioned within the enclosure on a side of the TD opposite the second device, and both the second device and the third device may present a visible output. For example, a display of the second device may be within the field of view of a front camera of the TD, while a display of the third device is within the field of view of a rear camera of the TD.

In some implementations, one or more devices in the enclosure may be caused to perform functions, and data may be acquired from the devices and used to generate an interface presenting information regarding performance of an application using one or more Application Programming Interfaces (API). For example, an API may be used to provide input data to a first device in the enclosure. The input data may be associated with metadata indicative of the time at which the input data was provided. The first device may present an output based on the input data. Data from the first device indicative of the output that was presented may be acquired using the API. This data may be associated with metadata indicative of the time at which the output was presented. For example, depending on one or more factors that may affect the performance of an application, an output may be presented at a different time than a time at which the input data was provided to a device. A second device in the enclosure may acquire data associated with the output using a camera or microphone. At least a portion of this data may be acquired from the second device using the API, and this data may be associated with metadata indicating the time at which the data was acquired. The times associated with each of the acquired data may be indicated in the interface and may be used to synchronize presentation of the information in the interface.

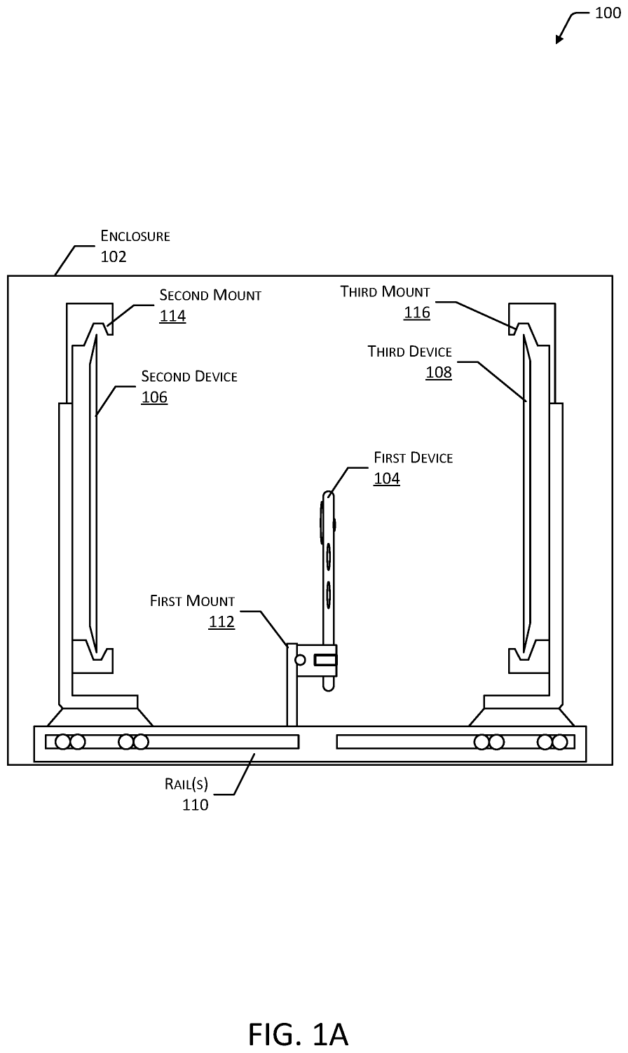

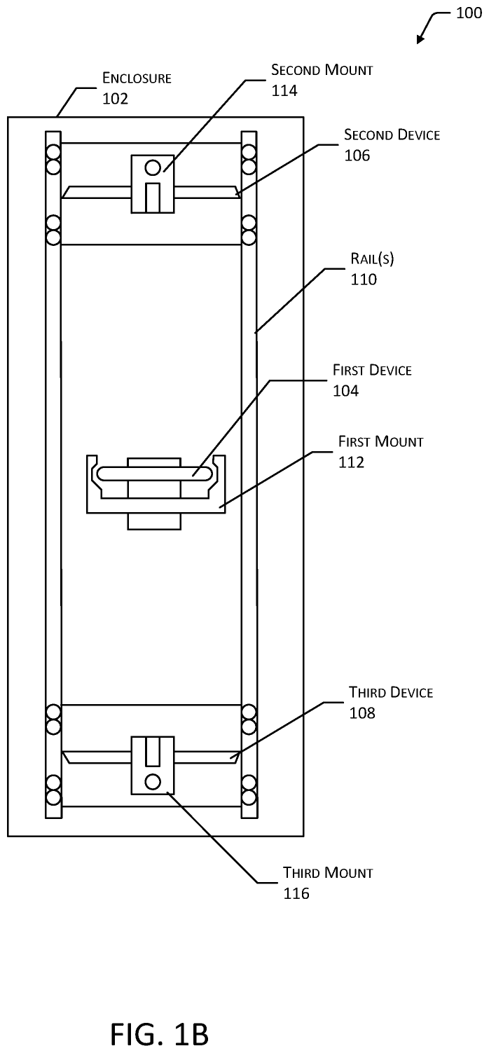

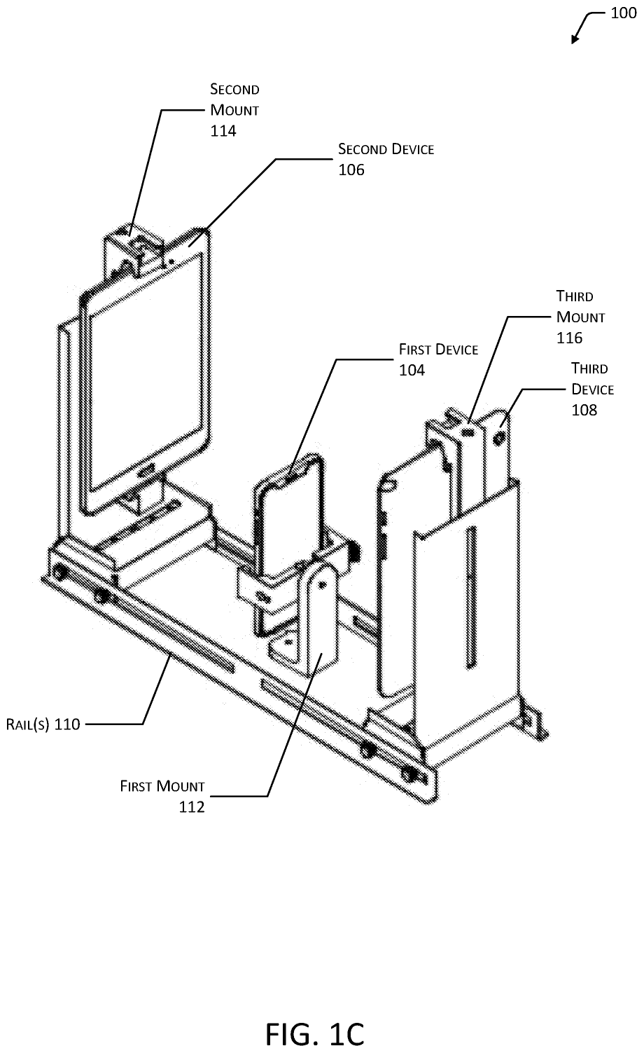

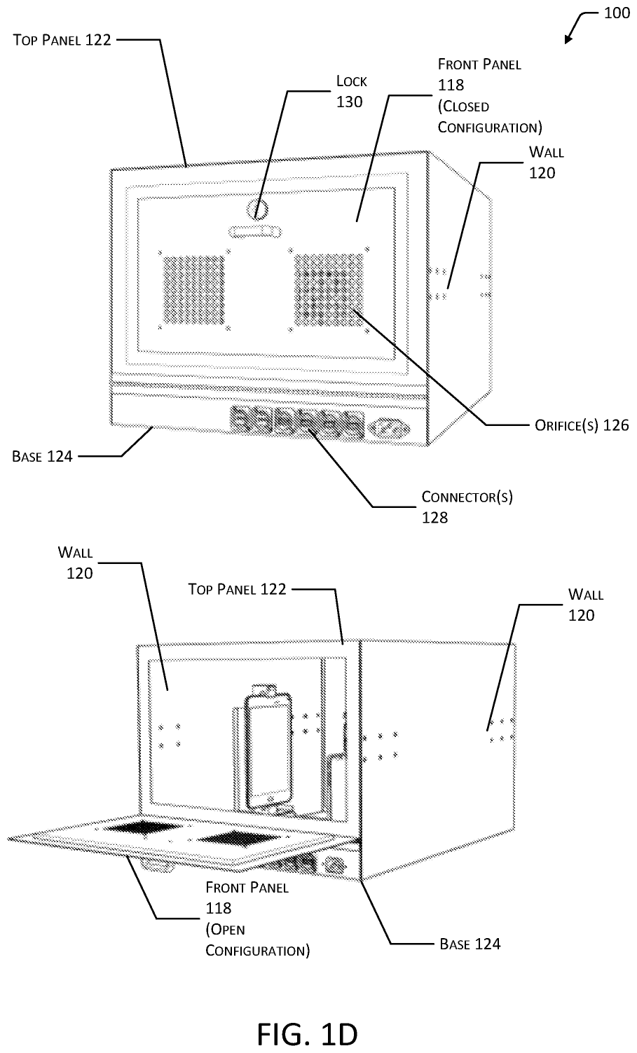

FIGS. 1A-1D depict an implementation of a system 100 in which performance of an application may be tested using multiple devices within an enclosure 102. Specifically, FIG. 1A depicts a diagrammatic side view of the system 100, FIG. 1B depicts a diagrammatic top view of the system 100, FIG. 1C depicts an isometric view of the system 100 with the structure of the enclosure 102 removed for visibility, and FIG. 1D depicts exterior views of the enclosure 102 in closed and open configurations. The enclosure 102 is shown having the shape of a rectangular box, however in other implementations, other shapes may be used. In one implementation, the enclosure 102 may have a width of approximately 17.29 inches, a depth of approximately 22.13 inches, and a height of approximately 13.7 inches, which is compatible for placement in a rack having a width of 19 inches that is typically used for storage of servers or other computing devices. Enclosures 102 that are sized for mounting in a rack or other type of fixture may enable multiple enclosures 102 to be stored in a small amount of space. For example, five enclosures 102 having the dimensions described previously may be placed in a standard 44/48U rack having a width of 19 inches. In some cases, one or more severs or other types of host devices that communicate with devices within the enclosure(s) 102 may also be placed in such a rack with the enclosure(s) 102. For example, a single server or host device may provide data to, or receive data from, devices in two or more enclosures 102.

The enclosure 102 may fully enclose the devices within. For example, an enclosure 102 having a rectangular box shape may have six panels. One or more of the panels may be openable to access devices within the enclosure 102, then closeable when testing performance of an application. The enclosure 102 may be formed from materials that limit the passage of light and sound from outside of the enclosure 102 to the interior, and from the interior of the enclosure 102 to the outside thereof. For example, the enclosure 102 may be formed primarily from steel and may include foam, rubber, opaque materials, gaskets, baffles, and so forth that may limit the transmission of light or sound. In some cases, one or more portions of the enclosure 102 may be formed from acetal plastic, or another material that may enable cellular signals or other types of signals to pass through the enclosure 102 to enable communication between an enclosed device and one or more devices external to the enclosure 102.

The system 100 shown in FIGS. 1A-1C includes three computing devices within the enclosure 102. However, in other implementations, a single computing device, two computing devices, or more than three computing devices may be used. Specifically, FIGS. 1A-1C depict a first device 104 positioned within the enclosure 102 between a second device 106 and a third device 108. The second device 106 and third device 108 are shown positioned proximate to one or more panels of the enclosure 102, while the first device 104 is shown positioned approximately equidistantly from the second device 106 and third device 108 at a position proximate to a center of the enclosure 102. However, in other implementations, the second device 106 or third device 108 may be spaced apart from the panels of the enclosure 102, the first device 104 may be positioned closer to one of the second device 106 or third device 108, or closer to one of the panels of the enclosure 102, and so forth. Any positions for the computing devices may be used that enable at least one device to acquire data associated with an output presented by another device.

FIGS. 1A-1C depict the first device 104 as a smart phone, and the second device 106 and third device 108 as tablet computers. However, in other implementations, one or more of the devices may include laptop or desktop computers, servers, wearable computing devices, set top boxes, or network-enabled speakers, cameras, displays, or microphones. The enclosure 102 may include one or more rails 110 along a surface thereof, such as a bottom panel, which may enable movement of one or more of the devices relative to one or more other devices. One or more mounts, brackets, clamps, clips, or other types of fixtures may be used to secure each of the devices to a surface of the enclosure 102 or to the rail(s) 110. For example, a first mount 112 may secure the first device 104 to a bottom panel of the enclosure 102, or in some implementations, to the rail(s) 110. FIGS. 1A-1C also depict a second mount 114 securing the second device 106 to the rail(s) 110 and a third mount 116 may securing the third device 108 to the rail(s) 110. In some implementations, one or more of the mounts may be movable within the enclosure 102, such as to position a secured device relative to one or more other devices. For example, FIGS. 1A-1C depict the second mount 114 engaged with the rail(s) 110 to enable movement of the second mount 114 and the secured second device 106 toward or away from the first device 104. Similarly, FIGS. 1A-1C depict the third mount 116 engaged with the rail(s) 110 to enable movement of the third mount 116 and the third device 108 toward or away from the first device 104. In some implementations, the first mount 112 may also be movable within the enclosure 102 to enable movement of the first device 104 relative to one or more other devices in the enclosure 102.

In some implementations, one or more of the mounts may enable movement of a secured device in a vertical or lateral direction within the enclosure 102, in addition to or in place of forward and rearward movement. For example, the position of a device within a portion of a corresponding mount that secures the device may be modified by securing different portions of the device using the mount or otherwise adjusting the position of the device relative to the mount. As another example, a mount may include multiple portions, at least one of which may be movable relative to another portion. For example, a first portion of a mount that engages a device may be movable in a vertical direction, a lateral direction, or both a vertical and a lateral direction relative to a second portion of the mount that is secured to the rail(s) 110 or to a surface of the enclosure 102.

The devices may be positioned in the enclosure 102 such that data regarding an output presented by one of the devices may be acquired using one or more of the other devices. For example, the first device 104 may present an output using a display, the second device 106 may be positioned such that at least a portion of the display is within a field of view of a camera of the second device 106, and the camera may be used to acquire data regarding the output. In some cases, a camera of the third device 108 may acquire data indicative of one or more exterior features of the first device 104, such as one or more LEDs or other features located on a rear side thereof. As another example, the first device 104 may emit an audio output using one or more speakers, and one or more of the second device 106 or third device 108 may acquire data regarding the output using one or more microphones. As yet another example, the second device 106, the third device 108, or both the second device 106 and third device 108 may present an output using a display, and the first device 104 may acquire data regarding the output(s) using one or more cameras. Continuing the example, the first device 104 may acquire data regarding an output presented by the second device 106 using a front-facing camera, and may acquire data regarding an output presented by the third device 108 using a rear-facing camera. As another example, the second device 106, the third device 108, or both the second device 106 and third device 108 may present an audio output, and the first device 104 may acquire data regarding the audio output using one or more microphones.

Enclosing each of the devices within the enclosure 102 may limit the transmission of light and sound from outside of the enclosure 102 to the interior thereof, which may prevent external light and sounds from affecting data that is acquired to determine performance of the application. Additionally, the enclosure 102 may prevent transmission of sound from within the interior of the enclosure 102 to the exterior, or viewing of a display output by an individual outside of the enclosure 102, which may protect the confidentiality of content presented on one or more of the devices.

As shown in FIG. 1D, the enclosure 102 may have the shape of a rectangular box. For example, the enclosure 102 is shown having six sides that include an openable front panel 118, one or more walls 120, a top panel 122, and a base 124. Each panel may be formed from generally rigid materials, such as steel, acetal plastic, wood, composite, rock, natural fibers, or combinations of materials. Additionally, each panel may be at least partially opaque to prevent transmission of light from the exterior of the enclosure 102 to the interior, or to prevent viewing of the interior of the enclosure by individuals located outside of the enclosure 102. The front panel 118 may be opened and closed to enable access to the interior of the enclosure 102, such as for placement and removal of devices. In some implementations, one or more other portions of the enclosure 102 may be openable to access the interior of the enclosure 102. In some implementations, the front panel 118 may include a lock 130 or other type of security feature to prevent unauthorized access to the interior of the enclosure 102. The lock 130 may be operated using a mechanical or electrical key, a keypad, audio inputs, and so forth. The front panel 118 or one or more other portions of the enclosure 102 may include one or more orifices 126, which may enable the transfer of heat from within the enclosure 102 to the exterior. In some implementations, one or more fans or other air-moving devices may be associated with one or more of the orifices 126. In some implementations, baffles or other sound-insulating materials such as rubber or foam may be associated with the orifices 126 to limit transmission of sound between the interior and exterior of the enclosure 102 through the orifices 126.

The enclosure 102 may also include one or more electrical connectors 128, or in some implementations, pass-through orifices, which may engage or accommodate conduits for transmitting electrical power, data, and so forth to and from devices in the enclosure 102. For example, a conduit for transmitting electrical power may be engaged with one of the connectors 128, which may in turn communicate with conduits within the enclosure 102 that transmit electrical power to devices within the enclosure 102. As another example, one or more of the connectors 128 may accommodate USB conduits, HDMI conduits, and so forth. For example, input data to cause presentation of an output may be provided to one or more of the devices within the enclosure 102 via one or more of the connectors 128.

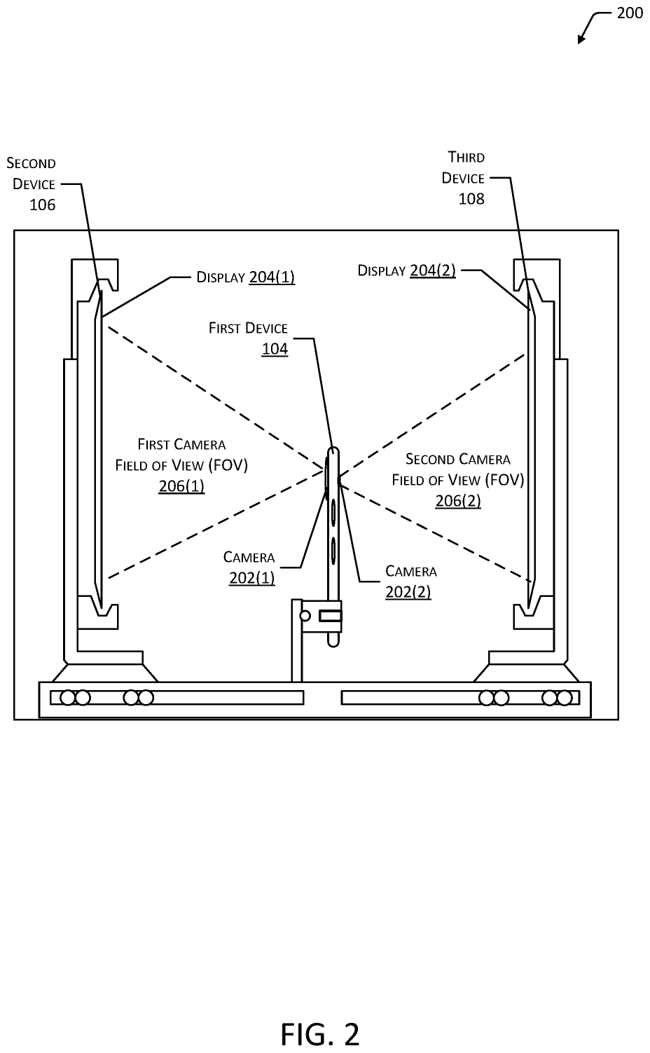

FIG. 2 depicts an implementation of a system 200 for testing performance of an application when using a device executing the application to acquire data regarding output presented by one or more other devices. As described with regard to FIGS. 1A-1C, a first device 104 may be positioned within an enclosure 102, such as by using a mount, bracket, or other device for retaining the first device 104 in a generally fixed position within the enclosure 102. A second device 106 may be positioned on a first side of the first device 104, and a third device 108 may be positioned on a second side of the first device 104 opposite the first side. The second device 106 and third device 108 may also be secured within the enclosure 102 using one or more mounts or similar fixtures. In some implementations, one or more of the first device 104, second device 106, or third device 108 may be movable relative to the other devices, such as through engagement with one or more rails 110 or through use of a mount having parts that are movable relative to the enclosure 102, the engaged device, or to other portions of the mount.

The first device 104 may execute an application for the purpose of testing performance of one or more functions of the application. For example, the functions of the application may include use of one or more cameras 202 associated with the first device 104 to acquire data. Specifically, FIG. 2 depicts the first device 104 including a first camera 202(1) on a first side of the first device 104 and a second camera 202(2) on a second side of the first device 104 opposite the first camera 202(1). For example, the first device 104 may include a smartphone, the first camera 202(1) may include a rear-facing camera of the smartphone, and the second camera 202(2) may include a front-facing camera of the smartphone.

The second device 106 may present an output using a display 204(1). The output may include one or more videos, images, patterns, colors, and so forth. At least a portion of the display 204(1) may be positioned within a field of view (FOV) 206(1) of the first camera 202(1). The third device 108 may also present an output using a display 204(2). The output presented by the third device 108 may be the same output or a different output than that presented by the second device 106. At least a portion of the display 204(2) of the third device 108 may be positioned within a field of view (FOV) 206(2) of the second camera 202(2). When the second device 106 and third device 108 present output, information regarding the input data that was provided to the second device 106 and third device 108 to cause the output, and information from the second device 106 and third device 108 regarding presentation of the output may be determined. Additionally, data regarding the output presented by the second device 106 and third device 108 may be determined from the first device 104, which may acquire at least a portion of the data using the cameras 202. The performance of the application with regard to use of the cameras 202 of the first device 104 may therefore be evaluated by using the first device 104 to determine information regarding the output presented by the other devices using the cameras 202. Placement of the devices within the enclosure 102 during such a test may limit interference caused by light or sound outside of the enclosure 102 and may also prevent access to the devices or to the presented content by unauthorized parties.

While FIG. 2 depicts an example in which visible outputs are presented by the second device 106 and third device 108 and data regarding the output(s) is acquired using the cameras 202 of the first device 104, other implementations may include audio outputs, or a combination of both audio and visible outputs. For example, the second device 106, the third device 108, or both the second device 106 and third device 108 may emit sound, and one or more microphones associated with the first device 104 may acquire data associated with the emitted sound.

In some implementations, the first device 104 may present a subsequent output in response to the output provided by the second device 106, the third device 108, or both the second device 106 and third device 108. For example, in response to a display output or audio output from the second device 106, third device 108, or both devices, the first device 104 may present a visible output using a display, an audio output using one or more speakers, or both visible and audio output. One or more of the second device 106 or the third device 108 may acquire data regarding the output from the first device 104 using one or more cameras or microphones. In such a case, performance of the application executed by the first device 104 may also be tested based in part on the output provided by the first device 104.

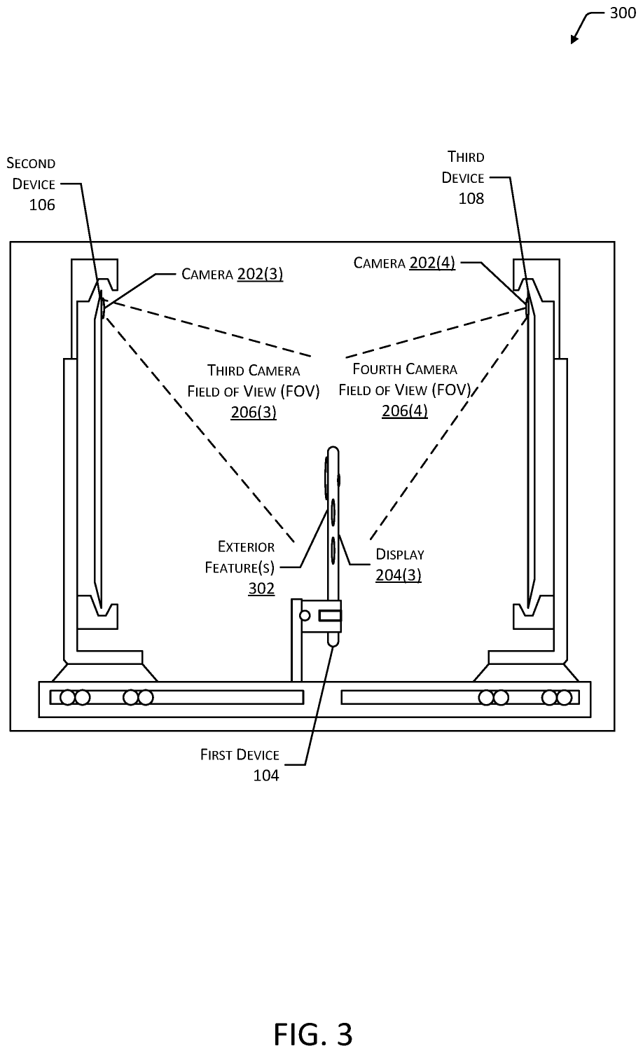

FIG. 3 depicts an implementation of a system 300 for testing performance of an application when using a device executing the application to present output and acquiring data regarding the output using one or more other devices. As described with regard to FIGS. 1A-1C, a first device 104 may be positioned within an enclosure 102, such as by using a mount or other device to engage the first device 104 to a portion of the enclosure 102. A second device 106 may be positioned on a first side of the first device 104, and a third device 108 may be positioned on a second side of the first device 104 opposite the first side, and in some cases may be secured to the enclosure 102 or to one or more rails 110 using one or more mounts or similar devices. As described with regard to FIGS. 1A and 2, in some implementations, one or more of the first device 104, second device 106, or third device 108 may be movable relative to the other devices.

The first device 104 may execute an application for the purpose of testing performance of one or more functions of the application. For example, the functions of the application may include use of a display 204(3) to present an output. Specifically, FIG. 3 depicts the first device 104 including a display 204(3) on one side thereof. For example, the first device 104 may include a smartphone having a display 204(3) and front-facing camera 202(2) on a first side, and a rear-facing camera 202(1) and one or more exterior features 302, such as LEDs, on a second side opposite the first side.

The second device 106 may include a camera 202(3) on a side thereof that faces the first device 104. Similarly, the third device 108 may include a camera 202(4) on a side that faces the first device 104. For example, the second device 106 and third device 108 may include tablet computers having front-facing cameras oriented toward the first device 104. As shown in FIG. 3, one or more exterior features 302 of the first device 104 may be within a field of view (FOV) 206(3) of the camera 202(3) of the second device 106. At least a portion of the display 204(3) of the first device 104 may be within a field of view (FOV) 206(4) of the camera 202(4) of the third device 108.

The first device 104 may present an output using the display 204(3). In some implementations, the output may be generated based on input data provided to or stored in association with the first device 104. The output may include one or more videos, images, patterns, colors, and so forth. Because at least a portion of the display 204(3) is within the FOV 206(4) of the camera 202(4) of the third device 108, the third device 108 may acquire data indicative of the output presented by the first device 104 using the camera 202(4). In some cases, use of the first device 104 may cause actuation of one or more exterior features 302, such as LEDs or other components. In such a case, data indicative of the exterior features 302 may be acquired using the camera 202(3) of the second device 106. When the first device 104 presents output based on input data, information regarding the input data that was provided to the first device 104 to cause the output, and information from the first device 104 regarding presentation of the output may be determined. Additionally, information regarding the output and regarding the exterior features 302 may be determined based on the data acquired by the cameras 202 of the second device 106 and third device 108. The performance of the application with regard to use of the display 204(3) of the first device 104, or the actuation of any exterior features 302 of the first device 104, may therefore be evaluated by using the second device 106 and third device 108 to determine information regarding the output presented by the first device 104.

While FIG. 3 depicts an example in which a visible output is presented by the first device 104, and data regarding the first device 104 is acquired using cameras 202 of the second device 106 and third device 108, other implementations may include audio outputs, or a combination of both audio and visible outputs. For example, the first device 104 may emit an audio output, and one or more microphones of the second device 106, the third device 108, or both the second device 106 and third device 108 may acquire data associated with the audio output. In some implementations, one or more of the second device 106 or the third device 108 may provide audio input to the first device 104 to cause the audio output. For example, the first device 104 may execute a smart assistant application or other type of application configured to generate output in response to audio input, or another type of input. One or more of the second device 106 or the third device 108 may emit sound, such as an audio command, request, or query. In response to this input, the first device 104 may present an audio output, a visible output, or both a visible and audio output. The second device 106 and third device 108 may acquire data indicative of the output using one or more cameras 202 or microphones.

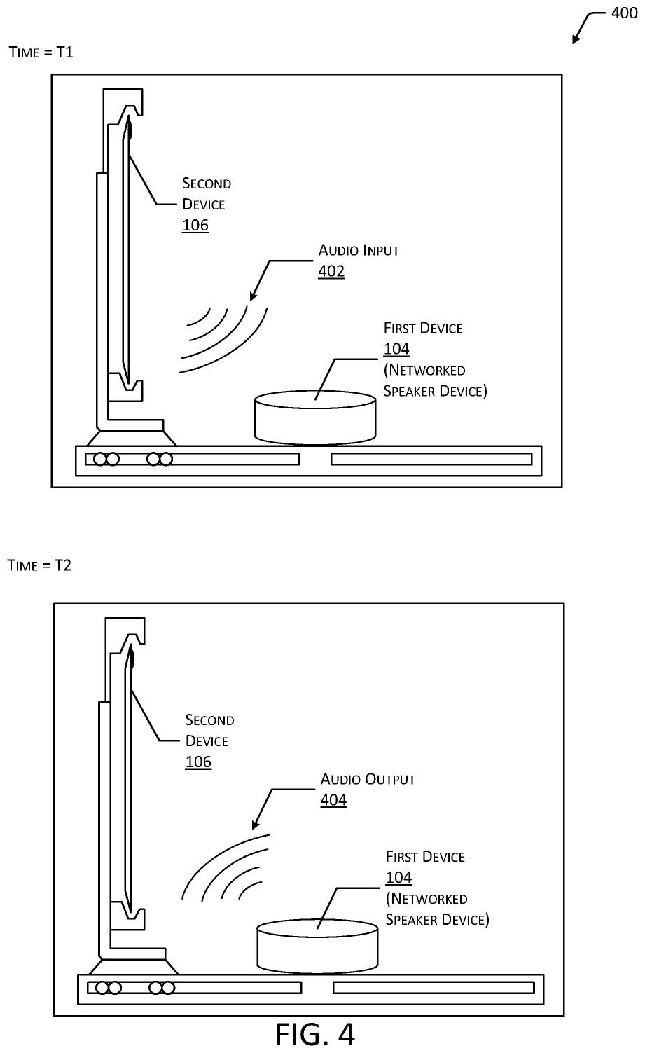

FIG. 4 depicts an implementation of a system 400 for testing performance of an application when using a device executing the application to receive audio input 402 and present an audio output 404 in response to the audio input 402. As described with regard to FIGS. 1A-1C, 2, and 3, a first device 104 and a second device 106 may be positioned within an enclosure 102 for the purpose of testing performance of an application executed by the first device 104. In the implementation shown in FIG. 4, the first device 104 includes a networked speaker device, such as a computing device executing a “smart assistant” application configured to receive voice commands or other types of audio input 402 and present audio output 404 in response to the audio input 402. The first device 104 and second device 106 may be secured within the enclosure 102 using a mount, bracket, or other device for retaining the first device 104 and second device 106 in a generally fixed position. While FIG. 4 depicts a system 400 that includes only two devices, in other implementations, a third device 108, as shown in FIGS. 2 and 3, may be included in the enclosure 102.

At a first time T1, the second device 106 may provide an audio input 402 using one or more speakers, and the first device 104 may acquire data based on the audio input 402 using one or more microphones. In other implementations, audio input 402 may be provided by another device within the enclosure 102 or external to the enclosure 102. In still other implementations, the first device 104 may be provided with input data representative of an audio input 402 using other methods, such as a USB conduit, a wireless network signal, and so forth. In yet other implementations, the first device 104 may access stored data representative of an audio input 402 without receiving input data from another source. While FIG. 4 depicts the second device 106 providing the audio input 402 to the first device 104, in other implementations in which a third device 108 or one or more additional devices are within the enclosure 102, other devices may also provide the audio input 402, or different audio inputs 402, to the first device 104.

At a second time T2, the first device 104 may present an audio output 404 using one or more speakers. The second device 106 may acquire data indicative of the audio output 404 using one or more microphones. In implementations where a third device 108 or one or more other devices are within the enclosure 102, other devices may also acquire data indicative of the audio output 404. Data regarding the audio output 404 may be determined from the first device 104 that presents the audio output 404, the second device 106 that receives the audio output 404, or both the first device 104 and the second device 106. Placement of the devices within the enclosure 102 may limit the transmission of sound from outside of the enclosure 102 into the enclosure 102, which may interfere with performance of the devices or with accurately determining performance of an application executed by the first device 104. Placement of the devices in the enclosure 102 may also limit transmission of sound from the devices to the outside of the enclosure 102, preventing unauthorized individuals from determining the content presented by the devices.

While FIG. 4 depicts an implementation in which audio input 402 and audio output 404 are exchanged by the devices in the enclosure 102, in other implementations, visible outputs may also be determined by one or more of the devices. For example, at least a portion of the first device 104 may be positioned within a field of view of a camera 202 of the second device 106. The camera 202 may be used to acquire data regarding one or more exterior features 302 of the first device 104, such as LEDs or other features that are actuated in association with presentation of the audio output 404. In other implementations, the first device 104 may include one or more displays 204, and a camera 202 associated with the second device 106 may acquire data regarding at least a portion of the output presented using the display(s) 204. In some cases, the second device 106 may present a visible output using one or more displays 204, and the first device 104 may acquire data regarding the visible output using one or more cameras 202. For example, an output presented by the first device 104 may be based in part on the visible output or other output presented by the second device 106.

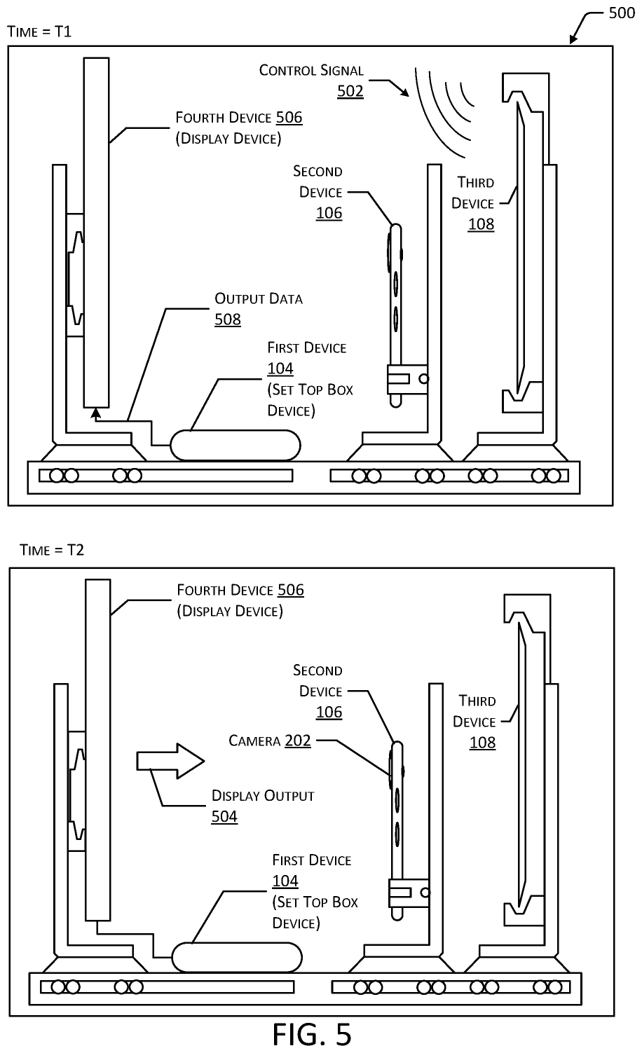

FIG. 5 depicts an implementation of a system 500 for testing performance of an application when using a device executing the application to receive a control signal 502 and cause a display device to present a display output 504 in response to the control signal 502. In the system 500 shown in FIG. 5, a first device 104, second device 106, third device 108, and fourth device 506 are shown within an enclosure 102. The first device 104 may include a set top box device, which may receive control signals 502 from one or more of the other devices and provide output data 508 to the fourth device 506, which may include a display device such as a monitor or television. The fourth device 506 may then present a display output 504 based on the output data 508. One or more cameras 202 associated with the second device 106 or third device 108 may acquire data indicative of the display output 504.

Specifically, at a first time T1, FIG. 5 depicts the third device 108 providing a control signal 502, which may be received by the first device 104. In response to the control signal 502, the first device 104 may provide output data 508 to the fourth device 506. At a second time T2, the fourth device 506 may present a display output 502. One or more cameras 202 associated with the second device 106 may acquire data associated with the display output 502. Use of one or more cameras 202 to acquire data associated with the display output 502 may enable data regarding performance of an application to be determined in cases where a particular device is unable to perform screen capture functions or otherwise record or store data associated with a display output 504, such as when content is protected using one or more DRM techniques. Placement of the device within the enclosure 102 may prevent unauthorized individuals outside of the enclosure 102 from viewing the display output 504.

While FIG. 5 depicts use of one or more cameras 202 to acquire data associated with a display output 504, in other implementations, one or more devices within the enclosure 102 may provide an audio output associated with the display output 504, and the second device 106 or another device in the enclosure 102 may determine data associated with the audio output using one or more microphones. For example, the fourth device 506 or first device 104 may include one or more speakers, or the first device 104 may provide output data 508 to a separate sound device that includes speakers to cause the audio output to be presented.

While the third device 108 is depicted as a tablet computer, any type of device may be used to provide the control signal 502. Additionally, in other implementations, the control signal 502 may be provided from the second device 106 and use of a separate third device 108 to provide the control signal 502 may be omitted. In still other implementations, a control signal 502 may be provided from another device outside of the enclosure 102, or input data indicative of a control signal 502 may be stored in association with the first device 104.

While the second device 106 is depicted as a smartphone, any type of device having a camera 202 or other sensor that is usable to acquire data associated with the display output 504 may be used. Additionally, as described previously, while the second device 106 having a camera 202 and a third device 108 that provides a control signal 502 are shown as separate devices, a single device may provide the control signal 502 and acquire data using a camera 202, and use of separate devices may be omitted.

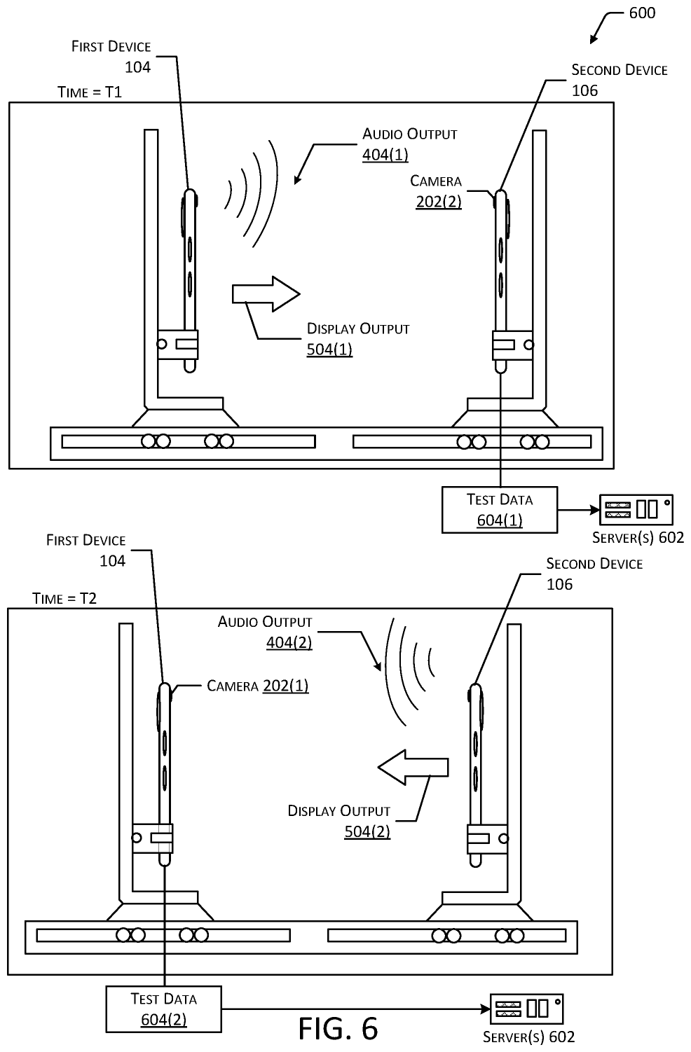

FIG. 6 depicts an implementation of a system 600 for using a first device 104 to determine data regarding performance of an application executed by a second device 106 and using the second device 106 to determine data regarding performance of an application executed by the first device 104. The first device 104 and second device 106 may be secured within an enclosure 102 to prevent interference of light or sound from outside of the enclosure 102. The enclosure 102 may also prevent transmission of output to individuals outside of the enclosure 102, unauthorized access to the devices, and so forth. In some implementations, the first device 104 and second device 106 may be mounted to one or more rails 110 or other portions of the enclosure 102 in a manner that permits movement of one or both devices.

The first device 104 may include a camera 202(1), display 204(1), microphone, and speaker. Similarly, the second device 106 may include a camera 202(2), display 204(2), microphone, and speaker. One or both of the first device 104 or the second device 106 may be used to execute one or more applications, such as to test performance of one or more functions associated with the application(s) under various conditions. For example, a function associated with an application may cause a device to present a visible output, to output audio, and so forth. As another example, a function associated with an application may cause a device to use a microphone or camera 202 to acquire data indicative of visible features or sound within one or more portions of the enclosure 102.

In some cases, a device may log, store, generate, or otherwise determine data indicative of output presented by the same device. For example, a device may use a screen capture function to record data indicative of output presented using a display 204. However, in some cases, it may not be possible to perform a screen capture function or one or more methods for determining data using the device. For example, a device may not be capable of performing a screen capture function, or presented content may be protected using one or more DRM functions that prevent use of screen capture functions. In such a case, use of a second device 106 to acquire data indicative of the output presented by a first device 104, such as through use of a camera 202 or microphone associated with the second device 106, may enable information regarding performance of the application to be determined despite the inability to determine data from the first device 104 that is presenting the output.

In other cases, multiple devices within an enclosure 102 may be used to execute an application, or to execute different applications, and other devices within the enclosure 102 may determine data regarding performance of the application. For example, at a first time T1, the first device 104 may present an audio output 404(1) and a display output 504(1) when executing an application. The second device 106 may acquire data regarding the audio output 404(1) using one or more microphones and may acquire data regarding the display output 504(1) using one or more cameras 202(2). Test data 604(1) indicative of performance of the application, such as characteristics of image data or video data determined using the camera 202(2) or characteristics of the audio output 404(1) determined using the microphone(s), may be determined from the second device 106 using one or more servers 602. The server(s) 602 may log or store the test data 604(1) and may use the test data 604(1) to generate an interface or other type of output indicative of performance of the application. For example, an interface may associate characteristics of a display output 504(1) determined by the second device 106 with times at which the characteristics occurred and the input data that was used by the first device 104 to generate the display output 504(1). In some cases, test data 604 may also be determined from the first device 104, such as data indicative of the input data that was used and data indicative of the output that was presented. However, in cases where data indicative of the output presented by the first device 104 cannot be determined, such as when a screen capture function is not able to be performed, data from the second device 106 may provide useful information regarding performance of the application. While FIG. 6 depicts one or more servers 602 external to the enclosure 102 determining the test data 604, in other implementations, one or more devices within the enclosure 102 may determine the test data 604, which may be stored for future transmission to another device or acquisition by an individual, or used for generation of an interface that presents information regarding the test data 604.

At a second time T2, the second device 106 may present an audio output 404(2) and a display output 504(2) when executing an application. The second device 106 may execute the same application as the first device 104, such as when performing a subsequent test of the same application. In other implementations, the second device 106 may execute a different application. The first device 104 may acquire data regarding the audio output 404(2) using one or more microphones and data regarding the display output 504(2) using one or more cameras 202(1). The server(s) 602 may determine test data 604(2) from the first device 104, which may be used to generate an interface that associates characteristics of the display output 504(2) and audio output 404(2) with the times that they occurred and the input data that caused presentation of the output. In some cases, test data 604 from the second device 106 may also be determined at the second time T2. In other cases, data indicative of output of the second device 106 may not be determined, such as when a device is incapable of performing screen capture or audio capture functions or if content is protected by DRM functions.

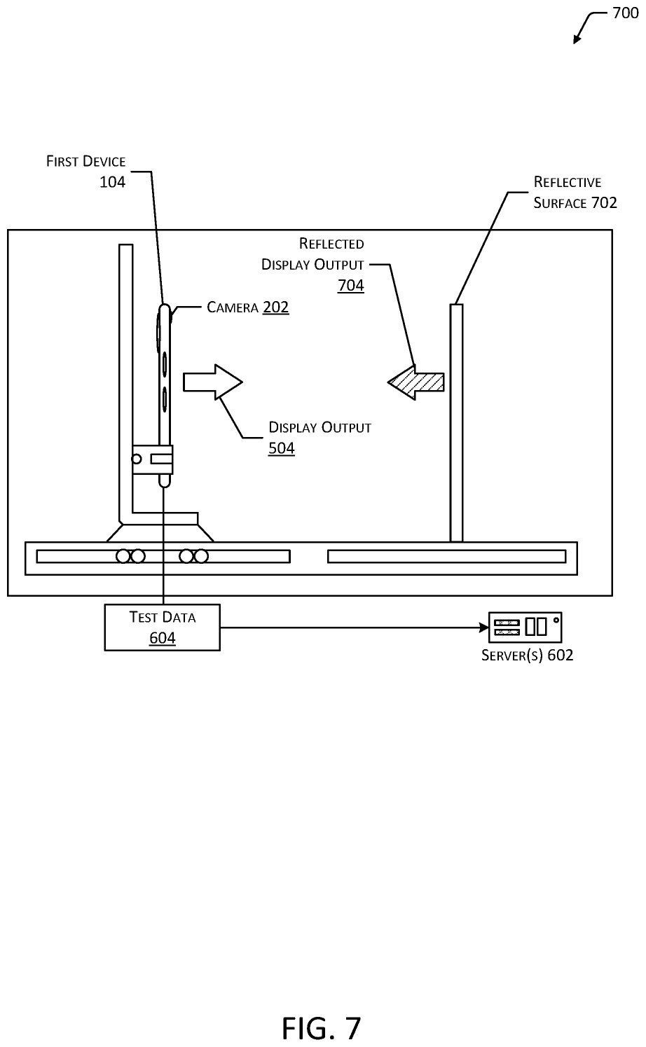

FIG. 7 depicts an implementation of a system 700 for using a single device within an enclosure 102 to determine performance of an application executed by the device. As described with regard to FIGS. 2-6, when a first device 104 presents a display output 504, one or more other devices within the enclosure 102 may acquire data indicative of the display output 504 using one or more cameras 202. The ability to acquire data regarding a display output 504 using cameras 202 may be useful when the first device 104 is unable to perform a screen capture function to directly determine data regarding the display output 504. In such a case, the data acquired using a camera 202 of another device may provide information indicative of the performance of an application executed by the first device 104 by providing information regarding the display output 504.

In the implementation shown in FIG. 7, a first device 104 may both provide a display output 504 and determine data indicative of the display output 504 using one or more cameras 202. Specifically, FIG. 7 depicts a reflective surface 702, such as a mirror, positioned in the enclosure 102 at a location where at least a portion of the display output 504 may be reflected by the reflective surface 702, illustrated as a reflected display output 704. At least a portion of the mirror or other reflective surface 702 may be positioned within a field of view of a camera 202 of the first device 104. As a result, the first device 104 may acquire data regarding the reflected display output 704 using the camera 202. One or more servers 602 may determine test data 604 indicative of at least a portion of the data acquired using the camera 202 and may generate an interface using the test data 604.

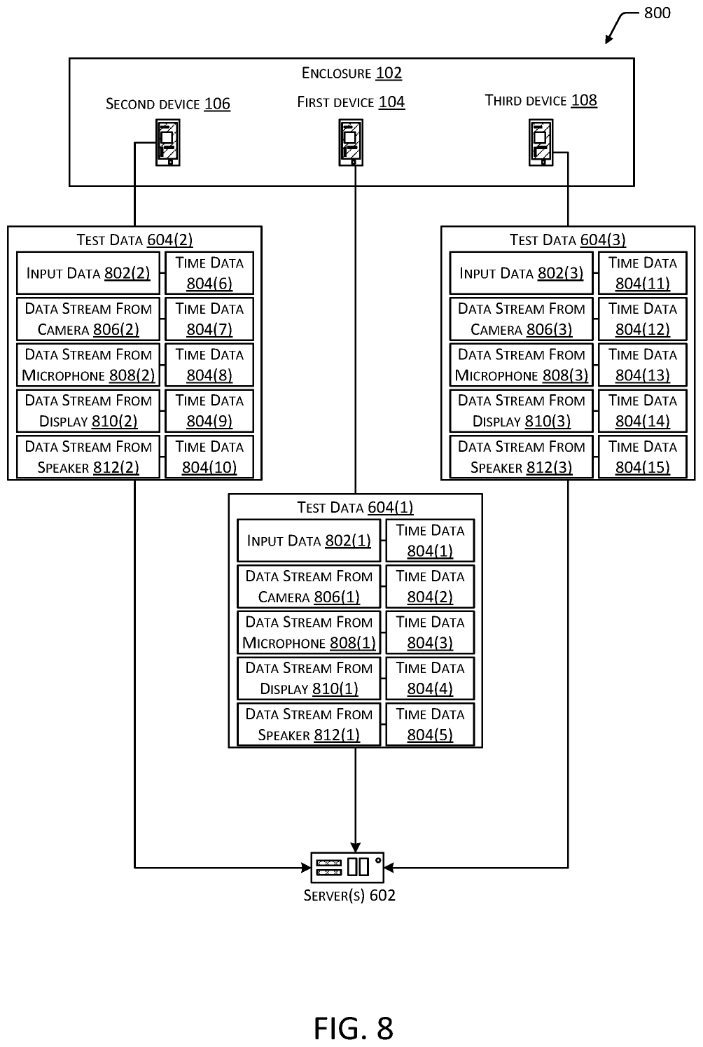

FIG. 8 is a block diagram 800 illustrating an implementation of a system for determining data regarding performance of an application from multiple devices within an enclosure 102. As described with regard to FIGS. 2-7, one or more devices may be placed in an enclosure 102. At least one device may execute an application, such as to test one or more functions associated with the application, performance of the application, performance of the device when executing the application, and so forth. In some cases, while the device executes the application, the device may present an output, and one or more other devices in the enclosure 102 may acquire data regarding the output using one or more microphones, cameras 202, or other input devices. For example, if a device executing an application is unable to perform screen capture or audio capture functions to record data associated with the presented output, data from other devices may be used to determine characteristics of the output, which may be used to determine information regarding performance of the application. In other cases, while the device executes the application, one or more other devices may present an output, and the device executing the application may acquire data regarding the output using one or more microphones, cameras 202, or other input devices. For example, a function of the executed application may be associated with use of the microphone(s) or camera(s) 202 of the device, and the information regarding the output presented by the other devices that is determined using the microphone(s) or camera(s) 202 may be compared with expected information or information obtained from the other devices to determine performance of the application.

One or more servers 602 may determine test data 604 from at least a portion of the devices in an enclosure 102. In some implementations, one or more devices in the enclosure 102 may be caused to perform functions, and test data 604 may be acquired from the devices using one or more APIs. For example, an API may be used to provide input data to one or more devices in an enclosure 102, to cause one or more devices to present an output, to cause one or more devices to acquire input using one or more cameras 202 or microphones, and so forth. An API may also be used to acquire test data 604 from one or more of the devices. For example, test data 604 may include data streams from one or more of a camera 202, microphone, display 204, or speaker associated with a device. Test data 604 determined from the devices may be used to generate an interface presenting information regarding performance of an application. In some implementations, the times associated with each of the acquired data streams may be indicated in the interface and may be used to synchronize presentation of the information in the interface.

For example, FIG. 8 depicts the server(s) 602 determining first test data 604(1) from a first device 104 in the enclosure 102. The first test data 604(1) may include an indication of input data 802(1) that was used by the first device 104 to generate output or to generate the test data 604(1). The input data 802(1) may be associated with time data 804(1) indicative of the time that the input data 802(1) was received or accessed by the first device 104. For example, the time that input data 802(1) is received by a device may differ from the time that an output based on the input data 802(1) is presented. The time data 804(1) may include a timestamp or other indication of a time that the input data 802(1) was received or a length of time that has elapsed between the time the input data 802(1) was received and another time.

The first test data 604(1) may also included a data stream from the camera 806(1) of the first device 104. The data stream from the camera 806(1) may include image data, video data, or other data acquired using one or more cameras 202 associated with the first device 104. For example, one or more other devices in the enclosure 102 may be positioned within a field of view of a camera 202 of the first device 104, and the first device 104 may acquire data indicative of an output presented by one or more other devices using the camera 202. In cases where one or more other devices do not present an output, or where a function associated with an application executed by the first device 104 does not include use of a camera 202, a data stream from the camera 806(1) of the first device may not be determined by the server(s) 602. The data stream from the camera 806(1) may be associated with time data 804(2) indicative of one or more times at which the data stream was acquired, generated, or transmitted to the server(s) 602.

The first test data 604(1) may additionally include a data stream from the microphone 808(1) of the first device 104. The data stream from the microphone 808(1) may include audio data, or in some cases, characteristics of the audio data, such as frequencies, amplitudes, and so forth. The data stream from the microphone 808(1) may also be associated with time data 804(3) indicative of a time at which data was acquired using the microphone. For example, one or more other devices in the enclosure 102 may present an audio output 404, and the first device 104 may acquire data indicative of the audio output 404 using a microphone. In cases where one or more other devices do not present an audio output 404, or where a function associated with an application executed by the first device 104 does not include use of a microphone, a data stream from the microphone 808(1) of the first device may not be determined by the server(s) 602. The data stream from the microphone 808(1) may be associated with time data 804(3) indicative of one or more times at which the data stream was acquired, generated, or transmitted to the server(s) 602.

The first test data 604(1) may also include a data stream from the display 810(1) of the first device 104. For example, the first device 104 may present a display output 504 based on received input data 802(1) or other data associated with the first device 104 or an application executed by the first device 104. In some cases, the display output 504 may be presented based on an output presented by another device in the enclosure 102, which may be detected by the first device 104 using a camera 202 or microphone. In some implementations, the data stream from the display 810(1) may be acquired using screen capture functions or other types of recording or logging functions associated with the first device 104. However, in some cases, if the first device 104 is not capable of performing screen capture functions or if the data presented using the display 204 of the first device 104 prevents use of screen capture functions, a data stream from the display 810(1) may not be determined by the server(s) 602. As another example, if the first device 104 is not caused to present a display output 504, a data stream from the display 810(1) may not be determined by the server(s) 602. The data stream from the display 810(1) may be associated with time data 804(4) indicative of one or more times at which the data stream was acquired, generated, or transmitted to the server(s) 602.

The first test data 604(1) may additionally include a data stream from the speaker 812(1) of the first device 104. For example, the first device 104 may present an audio output 404 based on received input data 802(1) or other data associated with the first device 104, or in response to an output presented by another device in the enclosure 102. In some implementations, the data stream from the speaker 812(1) may be acquired using audio capture functions or other types of recording or logging functions. In cases where the first device 104 is not usable to capture or otherwise record or log data that is output using a speaker, or if the first device 104 is not caused to present an audio output 404, a data stream from the speaker 812(1) may not be determined by the server(s) 602. The data stream from the speaker 812(1) may be associated with time data 804(5) indicative of one or more times at which the data stream was acquired, generated, or transmitted to the server(s) 602.

While FIG. 8 depicts the first test data 604(1) including an indication of input data 802(1) and four data streams, as well as time data 804 associated with the input data 802(1) and each data stream, in other implementations, one or more of the data streams, or one or more of the time data 804 may be omitted. For example, any combination of data streams from a camera 202, microphone, display 204, or speaker may be received, and all, none, or only a portion of the data streams may be associated with time data 804.

In a similar manner, second test data 604(2) may be determined from a second device 106 in the enclosure 102, and third test data 604(3) may be determined from a third device 108 in the enclosure 102. In cases where more than three devices are within an enclosure 102, additional test data 604 from other devices may be determined. In cases where fewer than three devices are within the enclosure 102, one or more of the second test data 604(2) or third test data 604(3) may be omitted.

The second test data 604(2) may include one or more of an indication of input data 802(2) used to generate an output, a data stream from a camera 806(2) of the second device 106, a data stream from a microphone 808(2) of the second device 106, a data stream from a display 810(2) of the second device 106, or a data stream from a speaker 812(2) of the second device 106. For example, the second device 106 may provide a visible output or audio output 404 using a display 204 or speaker, such as for receipt by the first device 104, and data streams indicative of these outputs may be determined by the server(s) 602. As another example, the second device 106 may acquire data indicative of an output by the first device 104 using a microphone or camera 202, and data streams indicative of this acquired data may be determined by the server(s) 602. In some implementations, at least a portion of the data streams determined from the second device 106 may be associated with time data 804 indicative of one or more times at which the data stream was acquired, generated, or transmitted to the server(s) 602. While FIG. 8 depicts the second test data 604(2) including an indication of input data 802(2) and four data streams associated with the second device 106, in other implementations, one or more of the data streams may be omitted.

In a similar manner, the third test data 604(3) may include one or more of an indication of input data 802(3) used to generate an output, a data stream from a camera 806(3) of the third device 108, a data stream from a microphone 808(3) of the third device 108, a data stream from a display 810(3) of the third device 108, or a data stream from a speaker 812(3) of the third device 108. For example, the third device 108 may provide output, such as for receipt by the first device 104, or acquire data indicative of output provided by the first device 104, and data streams indicative of these outputs or acquired data may be determined by the server(s) 602. In some implementations, at least a portion of the data streams determined from the third device 108 may be associated with time data 804 indicative of one or more times at which the data stream was acquired, generated, or transmitted to the server(s) 602. While FIG. 8 depicts the third test data 604(3) including an indication of input data 802(3) and four data streams associated with the third device 108, in other implementations, one or more of the data streams may be omitted.

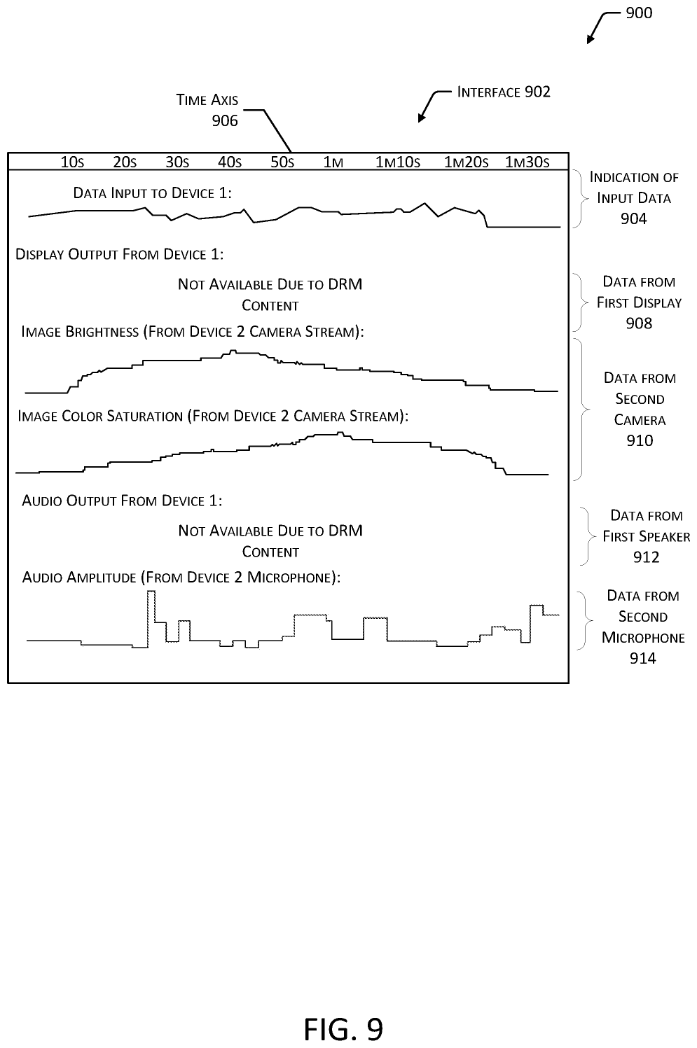

FIG. 9 is a diagram 900 depicting an example implementation of an interface 902 that may be generated based on data determined from devices in an enclosure 102. As described with regard to FIGS. 6-8, one or more servers 602 or other computing devices may determine test data 604 from one or more devices within an enclosure 102. For example, a first device 104 may execute an application and generate test data 604(1) indicative of the input data 802(1) associated with the application. The indication of the input data 802(1) may be associated with time data 804(1) that indicates a time at which the input data 802(1) was received by the first device 104. In some implementations, the test data 604(1) may also include one or more data streams indicative of data determined from a camera 202, microphone, display 204, or speaker of the first device 104. However, in some cases, one or more data streams may not be determined from the first device 104. For example, the first device 104 may be unable to provide a data stream from a display 810(1) if the first device 104 lacks the ability to perform a screen capture function or if the content presented by the first device 104 is associated with DRM protections that prevent use of a screen capture function.

A second device 106, and in some implementations, one or more additional devices in the enclosure 102 may also generate test data 604 indicative of the functions performed by the devices within the enclosure 102. For example, a second device 106 may acquire data indicative of an output presented by the first device 104 using a camera 202 or microphone. As another example, a second device 106 may present a display output 504 or audio output 404 using a display 204 or speaker, and the first device 104 may acquire data indicative of the output using a camera 202 or microphone. Test data 604(2) determined from the second device 106 may include an indication of input data 802(2) used by the second device 106 to generate an output, and one or more data streams determined from a camera 202, microphone, display 204, or speaker of the second device 106.

In some cases, data determined from the second device 106 may be used to determine information regarding performance of an application when data from the first device 104 is not available. For example, if the first device 104 is not usable to perform a screen capture function to determine data indicative of a display output 504 of the first device 104, a data stream from the camera 806(2) of the second device 106 may include information from which characteristics of the display output 504 of the first device 104 may be determined. In other cases, data determined from the second device 106 may be used in conjunction with data from the first device 104 to determine performance of the application. For example, test data 604(1) from the first device 104 may include a data stream from a display 810(1), while test data 604(2) from the second device 106 may include a data stream from a camera 806(2). Differences or similarities between the two data streams may indicate characteristics of the performance of the application executed by the first device 104. In a similar manner, test data 604(2) from the second device 106 indicative of a display output 504 may be compared to test data 604(1) from the first device 104 that includes a data stream from the camera 806(1) to determine performance of one or more functions that include the camera 202 of the first device 104.

Test data 604 from one or more devices may be used to generate an interface 902 that includes an indication of the input data 904 provided to a device executing an application to be tested. The indication of the input data 904 may be shown in association with an indication of one or more times that input was provided to the device, as indicated by a time axis 906 of the interface 902.

The interface 902 may also include data from the first display 908 of the first device 104. In cases where a data stream from the display 810(1) of the first device 104 is not acquired, a portion of the interface 902 that includes such an indication may be omitted, or a notification indicating the absence of this portion of the interface 902 may be presented. For example, if the first device 104 is not usable to perform a screen capture function due to DRM protections associated with a display output 504, an indication of the DRM protections may be presented in the interface 902, as shown in FIG. 9. The interface 902 may also include data determined from the second camera 910 of the second device 106. For example, a camera 202 of the second device 106 may acquire image data or video data that represents an output presented on a display 204 of the first device 104. In such a case, characteristics of the display output 504, such as an image brightness, an image saturation, or other characteristics may be determined based on the data stream from the camera 806(2) of the second device 106. The interface 902 may therefore present data from the second camera 910 of the second device 106, which may indicate characteristics of the display output 504 of the first device 104.

In a similar manner, the interface 902 may include data from a first speaker 912 of the first device 104, representative of an audio output 404 of the first device 104. For example, the interface 902 may present information regarding an amplitude of one or more frequencies of sound emitted by the first device 104. However, if the first device 104 is not usable to perform an audio capture function to determine data indicative of an audio output 404 of the first device 104, the interface 902 may omit presentation of this information or may present a notification indicating that this data stream was not able to be acquired. In such a case, a data stream from the microphone 808(2) of the second device 106 may include information from which characteristics of the audio output 404 of the first device 104 may be determined.

While FIG. 9 depicts a set of example values in the interface 902, such as image brightness, image color saturation, and audio amplitude, in other implementations other values indicative of characteristics of an audio output 404 or display output 504 may be presented. In other implementations, other values indicative of information regarding operation of the devices or performance of functions associated with an executed application may be presented in the interface 902, such as indications of processor or memory use, amounts of data exchanged using one or more networks, counts of connections with other devices, quantities of battery power or other types of power used, and so forth.

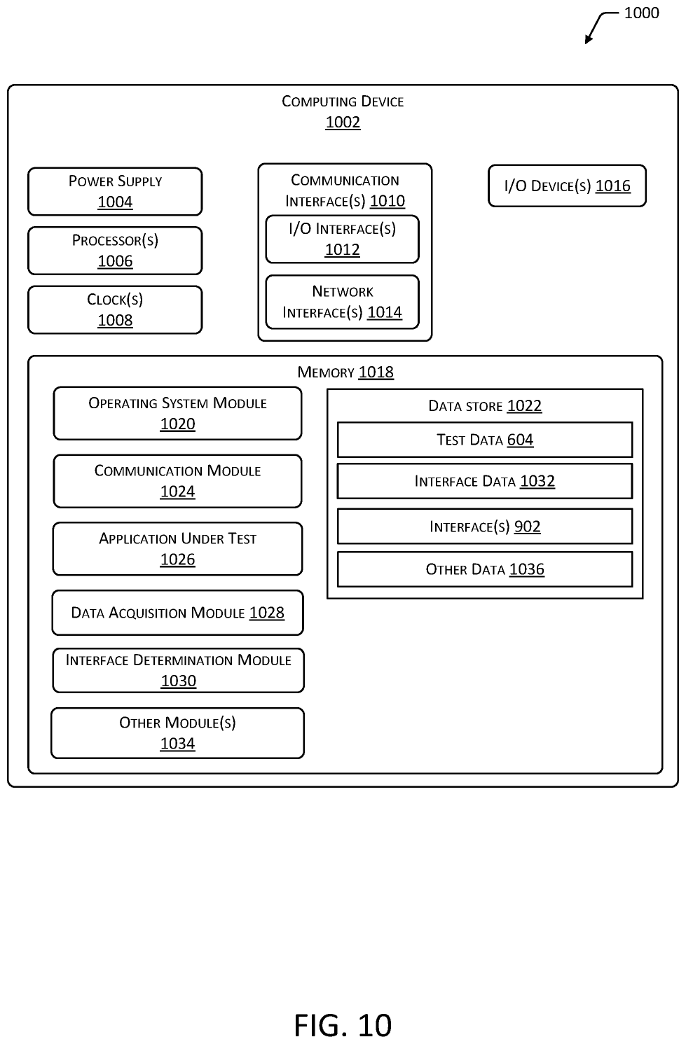

FIG. 10 is a block diagram 1000 depicting an implementation of a computing device 1002 within the present disclosure. The computing device 1002 may include one or more servers 602, as described with regard to FIGS. 6-8. In other implementations, the computing device 1002 may include one or more devices within an enclosure 102, or one or more devices in an environment with an enclosure 102, such as a server 602 or host device positioned in a rack or other storage area proximate to an enclosure 102. Any number and any type of computing devices 1002, including devices within an enclosure 102, devices in an environment with an enclosure 102, and devices remote from the devices in the enclosure 102 may be used. For example, while FIG. 10 depicts a single block diagram 1000 of an example computing device 1002, any number and any type of computing devices 1002 may be used to perform the functions described herein. For example, a portion of the functions described herein may be performed by one or more servers 602, while other functions may be performed by one or more devices within an enclosure 102.

One or more power supplies 1004 may be configured to provide electrical power suitable for operating the components of the computing device 1002. In some implementations, the power supply 1004 may include a rechargeable battery, fuel cell, photovoltaic cell, power conditioning circuitry, and so forth.

The computing device 1002 may include one or more hardware processor(s) 1006 (processors) configured to execute one or more stored instructions. The processor(s) 1006 may include one or more cores. One or more clock(s) 1008 may provide information indicative of date, time, ticks, and so forth. For example, the processor(s) 1006 may use data from the clock 1008 to generate a timestamp, trigger a preprogrammed action, determine time data 804 indicative of times when devices within an enclosure 102 receive input, generate output, and so forth.

The computing device 1002 may include one or more communication interfaces 1010, such as input/output (I/O) interfaces 1012, network interfaces 1014, and so forth. The communication interfaces 1010 may enable the computing device 1002, or components of the computing device 1002, to communicate with other computing devices 1002 or components of the other computing devices 1002. The I/O interfaces 1012 may include interfaces such as Inter-Integrated Circuit (I2C), Serial Peripheral Interface bus (SPI), Universal Serial Bus (USB) as promulgated by the USB Implementers Forum, RS-232, and so forth.

The I/O interface(s) 1012 may couple to one or more I/O devices 1016. The I/O devices 1016 may include any manner of input devices or output devices associated with the computing device 1002. For example, I/O devices 1016 may include touch sensors, displays 204, touch sensors integrated with displays (e.g., touchscreen displays), keyboards, mouse devices, microphones, image sensors, cameras 202, scanners, speakers or other types of audio output devices, haptic devices, printers, and so forth. The I/O devices 1016 may also include sensors for determining light, sound, vibration, and so forth. For example, in response to sensor data indicating light or sound within an enclosure 102 that may interfere with testing of an application, execution of an application may be delayed or a notification may be generated. In response to sensor data indicating light or sound within an enclosure 102 that is less than a threshold amount, an application may be executed and data associated with execution of the application and functions performed by one or more devices may be determined. In response to sensor data indicating vibration greater than a threshold amount, which may indicate damage or unauthorized access to an enclosure 102, a notification may be generated, one or more devices may be locked or deactivated, data may be deleted from one or more devices, and so forth. In some implementations, the I/O devices 1016 may be physically incorporated with the computing device 1002. In other implementations, I/O devices 1016 may be externally placed.

The network interfaces 1014 may be configured to provide communications between the computing device 1002 and other devices, such as the I/O devices 1016, routers, access points, and so forth. The network interfaces 1014 may include devices configured to couple to one or more networks including local area networks (LANs), wireless LANs (WLANs), wide area networks (WANs), wireless WANs, and so forth. For example, the network interfaces 1014 may include devices compatible with Ethernet, Wi-Fi, Bluetooth, ZigBee, Z-Wave, 3G, 4G, 5G, LTE, and so forth.

The computing device 1002 may include one or more busses or other internal communications hardware or software that allows for the transfer of data between the various modules and components of the computing device 1002.

As shown in FIG. 10, the computing device 1002 may include one or more memories 1018. The memory 1018 may include one or more computer-readable storage media (CRSM). The CRSM may be any one or more of an electronic storage medium, a magnetic storage medium, an optical storage medium, a quantum storage medium, a mechanical computer storage medium, and so forth. The memory 1018 may provide storage of computer-readable instructions, data structures, program modules, and other data for the operation of the computing device 1002. A few example modules are shown stored in the memory 1018, although the same functionality may alternatively be implemented in hardware, firmware, or as a system on a chip (SoC). In some implementations, the functionality described with regard to one or more of the modules may be incorporated within a software development kit (SDK), may be performed using one or more APIs, and so forth.

The memory 1018 may include one or more operating system (OS) modules 1020. The OS module 1020 may be configured to manage hardware resource devices such as the I/O interfaces 1012, the network interfaces 1014, the I/O devices 1016, and to provide various services to applications or modules executing on the processors 1006. The OS module 1020 may implement a variant of the FreeBSD operating system as promulgated by the FreeBSD Project; UNIX or a UNIX-like operating system; a variation of the Linux operating system as promulgated by Linus Torvalds; the Windows operating system from Microsoft Corporation of Redmond, Wash., USA; or other operating systems.

One or more data stores 1022 and one or more of the following modules may also be associated with the memory 1018. The modules may be executed as foreground applications, background tasks, daemons, and so forth. The data store(s) 1022 may use a flat file, database, linked list, tree, executable code, script, or other data structure to store information. In some implementations, the data store(s) 1022 or a portion of the data store(s) 1022 may be distributed across one or more other devices including other computing devices 1002, network attached storage devices, and so forth.

A communication module 1024 may be configured to establish communications with one or more other computing devices 1002. Communications may be authenticated, encrypted, and so forth.

The memory 1018 may also store one or more applications under test 1026 (AUT). An AUT 1026 may include code or other types of computer-executable instructions stored in association with one or more devices within an enclosure 102. Execution of the AUT 1026 may cause a device in an enclosure 102 to perform one or more functions associated with one or more I/O devices 1016, such as acquiring data using a camera 202 or microphone, or presenting output using a display 204 or speaker. Characteristics of the data acquired or presented by a device executing the AUT 1026 may be used to determine performance of the AUT 1026 under various conditions. For example, a particular function of the AUT 1026 may be recorded over time, and the network conditions, device conditions, and other factors that may affect performance of the AUT 1026 at particular times may also be determined. An interface 902 may be presented that associates performance of the AUT 1026 with times at which the performance occurred and other characteristics of the AUT 1026, device, network, and so forth.

The memory 1018 may also include a data acquisition module 1028. The data acquisition module 1028 may acquire data streams from one or more devices within an enclosure 102. In some implementations, data streams may be acquired from devices using one or more APIs. For example, an existing API within one or more devices in an enclosure 102, such as an API for using Bluetooth audio functions, may be extended to provide data streams to one or more other computing devices 1002. In some implementations, data streams associated with one or more devices may be associated with time data 804 indicative of a time at which the data streams were generated, or the data acquisition module 1028 may associate time data 804 with acquired data streams. Based on the time data 804, the data acquisition module 1028, or another module in the memory 1018, may synchronize the data streams, such that characteristics of functions performed by devices within an enclosure 102 at particular times may be determined.

The memory 1018 may additionally include an interface determination module 1030. The interface determination module 1030 may generate one or more interfaces 902 or other types of output based in part on the data streams acquired from one or more devices. For example, as described with regard to FIG. 9, an interface may associate characteristics of functions performed by devices in an enclosure 102 with characteristics of other functions over time. Continuing the example, an interface 902 may associate values for particular characteristics with an indication of a time at which the values occurred. Interface data 1032 stored in association with the computing device 1002 may control the layout, format, and content that is included in an interface 902. In some implementations, the content that is included in an interface 902 may be determined based on one or more user input settings or configurations.

Other modules 1034 may also be present in the memory 1018. For example, other modules 1034 may include user interface modules for generating user interfaces for controlling portions of a test process for an application under test 1026. Other modules 1034 may include logging modules for determining log data based on characteristics of one or more computing devices 1002 or networks during performance of functions associated with an application under test 1026. Other modules 1034 may also include encryption modules to encrypt and decrypt communications between computing devices 1002, authentication modules to authenticate communications sent or received by computing devices 1002, a permission module to assign, determine, and manage user permissions to access or modify data associated with computing devices 1002, and so forth.

Other data 1036 within the data store(s) 1022 may include configurations, settings, preferences, and default values associated with computing devices 1002. Other data 1036 may also include encryption keys and schema, access credentials, threshold data, and so forth. Other data 1036 may additionally include rules or criteria for determining when to cause devices in an enclosure 102 to perform functions, such as acquisition of data using cameras 202 or microphones, presentation of output, particular information to include in an interface 902 based on determined data streams, and so forth.

In different implementations, different computing devices 1002 may have different capabilities or capacities. For example, servers 602 may have greater processing capabilities or data storage capacity than devices placed in enclosures 102.

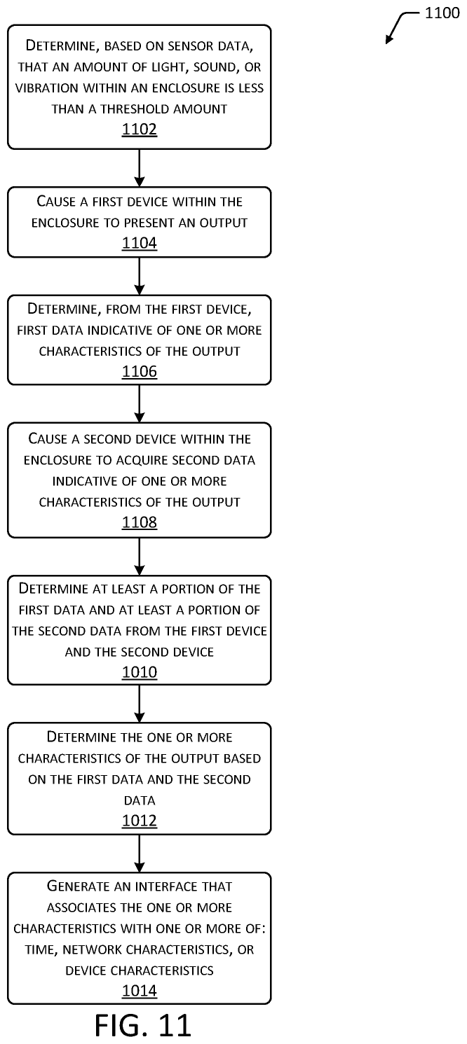

FIG. 11 is a flow diagram 1100 illustrating an implementation of a method for determining data indicative of performance of an application. As described with regard to FIGS. 1-9, one or more devices may be placed within an enclosure 102 to isolate the devices from sound or light external to the enclosure 102, prevent unauthorized access to the devices, and prevent unauthorized individuals from viewing or listening to content presented by the devices. At 1102, a determination may be made, based on sensor data, that an amount of ambient light, sound, or vibration within an enclosure 102 is less than a threshold amount. For example, one or more devices within the enclosure 102 may use a camera 202 to detect an amount of light, a microphone to detect an amount of sound, an accelerometer to detect an amount of vibration, and so forth. In other implementations, one or more separate sensors associated with the enclosure 102 may be used to determine an amount of sound, light, or vibration associated with the enclosure 102. In some cases, excessive transmission of sound or light from outside of the enclosure 102 to the interior may interfere with acquisition of accurate data. Additionally, the presence of sound or light that is greater than a threshold amount may indicate that the enclosure 102 is damaged or open. In a similar manner, the presence of vibration greater than a threshold amount may indicate that the enclosure has been moved or tampered with. A test to determine performance of an application may be initiated in response to the amount of light, sound, or vibration being less than the threshold amount. In cases where the light, sound, or vibration associated with the enclosure 102 is greater than the threshold amount, actions associated with a test to determine performance of an application may be ceased or delayed, and in some cases, a notification indicative of the light, sound, or vibration may be generated.

At 1104, a first device 104 within the enclosure 102 may be caused to present an output. In some implementations, the first device 104 may be executing an AUT 1026, and the output may be associated with the AUT 1026. For example, one or more functions associated with the AUT 1026 may cause the first device 104 to present one or more images or video using a display 204, audio using one or more speakers, and so forth. In other implementations, another device in the enclosure 102 may be executing an AUT 1026, and the first device 104 may be caused to present an output to determine performance of the AUT 1026 based on input received by the other device. For example, the first device 104 may present a display output 504, and a device executing the AUT 1026 may acquire data indicative of the display output 504 using a camera 202. As another example, the first device 104 may present audio output 404, and a device executing the AUT 1026 may acquire data indicative of the audio output 404 using a microphone.

At 1106, first data may be determined from the first device 104. The first data may be indicative of one or more characteristics of the output presented by the first device 104. For example, the first device 104 may perform screen capture or audio capture functions to determine data indicative of a presented output. In cases where the first device 104 is unable to perform screen capture or audio capture functions, such as when content is associated with DRM protections, the first data may include other information. For example, the first device 104 may determine the input data, or characteristics of the input data, used to generate the output. As yet another example, the first device 104 may determine data indicative of components of the first device 104 that are used to present the output, such as an indication of processor or memory utilization, networks that are accessed, amounts of data that are transmitted or received, particular device components that are active, amounts of power consumed by particular functions, and so forth.

At 1108, a second device 106 within the enclosure 102 may be caused to acquire second data indicative of one or more characteristics of the output presented using the first device 104. For example, at least a portion of a display 204 of the first device 104 may be positioned within a field of view of a camera 202 of the second device 106, and the second data may include image data or video data acquired using the camera 202. As another example, the first device 104 may present an audio output 404, and the second data may include audio data acquired using one or more microphones of the second device 106. In cases where the first device 104 is unable to use screen capture or audio capture functions, the second data acquired using the second device 106 may be used to determine information regarding the output presented by the first device 104. Additionally, the second data may include other information, such as information regarding input received by the second device 106, components of the second device 106 that are used to acquire the second data, such as an indication of processor or memory utilization, networks that are accessed, amounts of data that are transmitted or received, particular device components that are active, amounts of power consumed by particular functions, and so forth.

In some implementations, a third device 108 or one or more additional devices in the enclosure 102 may present output, as indicated in block 1106, or acquire data regarding a presented output, as indicated in block 1108. For example, as described with regard to FIG. 2, a first device 104 executing an AUT 1026 may acquire data regarding display output 504 presented using two other devices, using cameras 202 positioned on opposite sides of the third device 108. As another example, as described with regard to FIG. 3, a first device 104 executing an AUT 1026 may present a display output 504, and two or more other devices in the enclosure 102 may acquire data using one or more cameras 202 that is indicative of the display output 504 and one or more exterior features 302 of the first device 104.

As described previously, either the first device 104 in block 1104 or the second device 106 in block 1108 may execute an AUT 1026. For example, the AUT 1026 may cause the first device 104 to present an output, while the second device 106 may determine data indicative of the output. However, in other cases, the AUT 1026 may cause the second device 106 to use a camera 202 or microphone to acquire input, and the first device 104 may be caused to present an output that may be used as input by the second device 106 executing the AUT 1026.

At 1010, at least a portion of the first data and at least a portion of the second data may be determined from the first device 104 and the second device 106. For example, one or more servers 602 or other computing devices 1002 may acquire at least a portion of the first data and at least a portion of the second data from devices within an enclosure 102, in some cases using one or more APIs 1026. In other implementations, one of the devices in the enclosure 102 or another device in an environment with the enclosure 102 may perform the functions described with regard to the server(s) 602.

At 1012, one or more characteristics of the output may be determined based on the first data and the second data. For example, the server(s) 602 or other computing device(s) 1002 that receive the data may analyze the data, process the data (such as by cropping or rotating image data, down-sampling audio data, and so forth), compare the data to one or more threshold values, and so forth, to determine values for one or more characteristics of the output. Performance of an AUT 1026 may be determined based in part on characteristics of the output itself if the first device 104 is executing the AUT 1026, or on characteristics of the output determined from data acquired by the second device 106 if the second device 106 is executing the AUT 1026.

At 1014, an interface 902 may be generated that associates the one or more determined characteristics with one or more of: time, network characteristics, or device characteristics. For example, as described with regard to FIG. 9, an interface 902 may include a time axis 904, and the position of a representation of one or more characteristics of an output along the time axis 904 may represent a time at which a value for the characteristic occurred. In other cases, an interface 902 may present data such as values indicative of processor or memory utilization, networks that are accessed, amounts of data that are transmitted or received, particular device components that are active, amounts of power consumed by particular functions, and so forth. Presentation of these values in association with corresponding characteristics of the output determined by a device executing the AUT 1026 or by another device within the enclosure 102 may be used to determine performance of one or more functions associated with the AUT 1026.

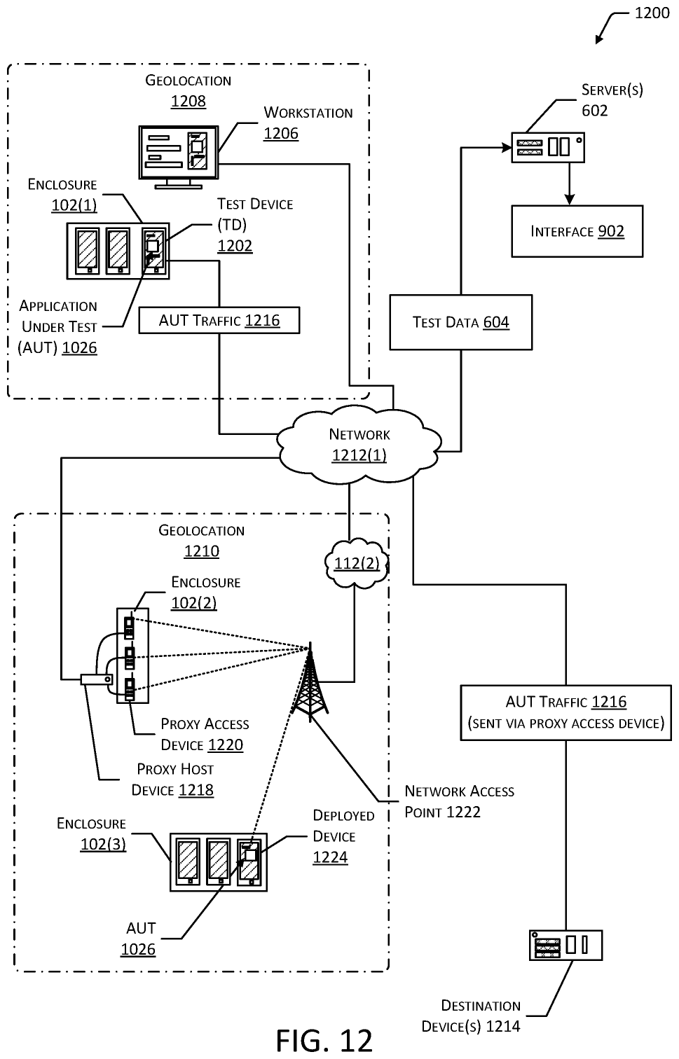

FIG. 12 depicts an implementation of a system 1200 for testing applications that utilize network resources, in which various metrics, including characteristics of output presented by a test device (TD) 1202 or input received by the TD 1202 while executing an application, may be determined. An application under test (AUT) 1026 may be executed on one or more different types of computing devices, such as a TD 1202, a workstation 1206, and so forth. Test devices 1202 and workstations 1206 may include any type of computing device including, without limitation, portable computing devices such as smartphones, laptops, or tablet computers, wearable computing devices, embedded devices, and personal computing devices such as desktop computers, computing devices associated with vehicles, servers, computing devices associated with appliances or media devices, set top box devices, smart televisions, networked speaker devices, and so forth. For example, the TD 1202 may be placed within an enclosure 102(1) with one or more other devices, and when executing the AUT 1026, the TD 1202 may present an output that may be determined by the other device(s) or acquire input based on output presented by the other device(s). The AUT 1026 may perform any number and any type of functions including, without limitation, retrieval or transmission of data, presentation of data using an output device such as a display 204 or speaker, acquisition of data using an input device such a camera 202 or microphone, processing of data, and so forth. The AUT 1026 may be an application that is at any stage in a development or maintenance lifecycle. For example, the AUT 1026 may include software that has not yet been released (e.g., an alpha, prerelease, or pre-launch version), or may include a previously released version that is undergoing testing. In some implementations, the workstation 1206, the TD 1202, or one or more computing devices in communication with the workstation 1206 or TD 1202 may include an integrated development environment (IDE) to facilitate the creation and editing of program code, debugging, compiling, and so forth.

In some implementations, the workstation 1206, TD 1202, or other computing device(s) may include an emulator or simulator that is designed to execute the AUT 1026 as though the AUT 1026 were executing on another piece of hardware, using a different operating system, and so forth. For example, the TD 1202 or workstation 1206 on which the AUT 1026 is executed may be located at a first geolocation 1208, which may be geographically separate from a second geolocation 1210. The first geolocation 1208 and second geolocation 1210 may include any type of geographic location, such as a particular room, building, city, state, country, and so forth. For example, a geographic location may be specified by a set of coordinates with regard to latitude and longitude on the surface of the Earth.

One or more of the TD 1202 or workstation 1206 may be connected to a first network 1212(1). The first network 1212(1) may, in turn, be connected to or be part of a larger network. For example, the first network 1212(1) may comprise the Internet, or the first network 1212(1) may be in communication with the Internet. The connection used by the TD 1202 or workstation 1206 may include, without limitation, a wired Ethernet connection, a wireless local area network (WLAN) connection such as Wi-Fi, and so forth. For example, the first geolocation 1208 may include an office, and the TD 1202 may connect to a local Wi-Fi access point that is connected via an Ethernet cable to a router. The router, in turn, may be connected to a cable modem that provides connectivity to the Internet. During operation, the AUT 1026 may access one or more external resources. For example, external resources may be stored in association with one or more destination devices 1214. The destination device(s) 1214 may include any number and any type of computing devices including, without limitation, the types of computing devices described with regard to the TD 1202 or workstation 1206.

The AUT 1026 may access, generate, transmit, or receive data. For example, the AUT 1026 may cause AUT traffic 1216 to be exchanged with one or more destination devices 1214 during operation. Traditionally, the AUT traffic 1216 associated with the TD 1202 at the first geolocation 1208 would be sent to the first network 1212(1), and then to the destination device(s) 1214. However, this traditional situation may only enable test data 604 to be generated based on the conditions associated with the first geolocation 1208 and first network 1212(1). For example, the characteristics of other networks or devices located at other geolocations may cause characteristics of an output presented by a TD 1202 or input acquired by the TD 1202 to differ. However, this information may not be discoverable using test data 604 that is associated only with the first geolocation 1208 and first network 1212(1).

To enable the AUT 1026 to be tested under conditions associated with different locations, such as the second geolocation 1210, and different networks 1212, a software development kit (SDK) may be incorporated into the AUT 1026. In other implementations, techniques other than an SDK may be used to provide the functionality described herein. For example, lines of computer code that provide the functionality of at least a portion of the SDK may be incorporated into the code base of the AUT 1026. The SDK may provide a user interface that allows for the redirection of the AUT traffic 1216. For example, the SDK may include instructions to establish communication with one or more servers 602 or other computing devices, which may include modules for coordinating the activities of devices and analyzing data determined from the devices. As described with regard to FIGS. 6-11, the server(s) 602 may determine test data 604 indicative of characteristics of output or input associated with a TD 1202 executing the AUT 1026. Other types of data associated with the AUT 1026 may also be acquired, such as data relating to video quality or other video characteristics, data indicative of network conditions, data indicative of the particular functions performed by a device or components of the device that are used while executing the AUT 1026, data relating to power used by a TD 1202 to perform various functions, and so forth.

In other implementations, an SDK may be used to determine data associated with functions performed by the AUT 1026 without requiring transmission of the data to other devices. For example, a TD 1202, workstation 1206, or other device executing an AUT 1026 may determine test data 604 indicative of characteristics of output or input associated with a TD 1202 without transmitting data to the server(s) 602. In other cases, the SDK executing on the TD 1202, workstation 1206, or other device may determine the test data 604.

In cases where data is sent to a server 602, the server 602 may coordinate the activities of one or more proxy host devices 1218 or proxy access devices 1220. A proxy host device 1218 may connect to the first network 1212(1) and to one or more of the proxy access devices 1220. In one implementation, the proxy host device 1218 may include a server 602, desktop computer, tablet, or other type of computing device to which multiple proxy access devices 1220 are connected using a wired connection, such as a cable connecting each proxy access device 1220 to a USB port of the proxy host device 1218. While FIG. 12 depicts a single proxy host device 1218 and three proxy access devices 1220, any number of proxy host devices 1218 and proxy access devices 1220 may be used. For example, proxy host devices 1218 and proxy access devices 1220 may be placed in an enclosure 102(2) to prevent unauthorized access to the devices, unauthorized transmission of content presented using the devices to individuals outside of the enclosure 102(2), and to enable output presented by one or more of the devices to be determined by one or more of the other devices within the enclosure 102(2).

The proxy access devices 1220 may connect to a network access point 1222 that provides connectivity to a second network 1212(2). Use of the proxy access devices 1220 to perform functions associated with an AUT 1026 may therefore enable data regarding performance of the functions to be determined when different types of devices are used, and when a second network 1212(2) having different characteristics than the first network 1212(1) is used. For example, the proxy access devices 1220 may include commodity cellphones, the network access points 1222 may include cell phone towers, and the second network 1212(2) may include a WWAN, such as a wireless cellular data network (WCDN). The second network 1212(2) may in turn communicate with the first network 1212(1). For example, a WCDN operated by a telecommunication company may interconnect or have a peering agreement with an Internet backbone provider. As a result, a user of the second network 1212(2) may be able to access resources on the first network 1212(1), and vice versa. In some implementations, the proxy access devices 1220 may be capable of communication with the destination device(s) 1214 or other devices using the second network 1212(2) or another network, such as a cellular network, without communicating using the first network 1212(1).

The proxy access devices 1220 may be located at the second geolocation 1210, which may be geographically removed from the first geolocation 1208 where the TD 1202 is located. For example, the proxy access devices 1220 may be located in another city, state, country, and so forth that differs from the location of the TD 1202. As part of the testing process for the AUT 1026, a user interface may be presented to enable a user at the first geolocation 1208 to select one or more of a particular geolocation, such as the second geolocation 1210, or particular proxy access device 1220 to use during testing. The server(s) 602 may maintain information about the proxy access devices 1220, such as geolocation, availability, cost, characteristics of the proxy access device 1220, and so forth. The server(s) 602 may coordinate establishment of a connection between the AUT 1026 and the proxy access device 1220 that was selected.

During testing, the AUT traffic 1216 may be routed through the first network 1212(1) to the proxy host device 1218, then through the proxy access device 1220 to the second network 1212(2), and then on to the first network 1212(1) to ultimately arrive at the destination device 1214. The AUT traffic 1216 may include outbound application traffic sent from the AUT 1026 to the destination device 1214 and inbound application traffic sent from the destination device 1214 to the AUT 1026. In some cases, at least a portion of the AUT traffic 1216 may include test data 604 indicative of an output presented by a device or input received by the device.

During operation, the AUT 1026 may direct outbound application traffic to the proxy host device 1218, which transfers the outbound application traffic to the proxy access device 1220, which then sends the outbound application traffic to the second network 1212(2). The second network 1212(2) may send the outbound application traffic to the destination device 1214. Inbound application traffic from the destination device 1214 may follow the reverse path. The server(s) 602, or one or more other devices, such as devices executing the SDK, may collect the test data 604 or other log data associated with operation of the system 1200, such as information associated with operation of the proxy access device 1220, packet capture of data transferred by the proxy host device 1218, and so forth. Log data may indicate, for a particular instant in time, one or more of: a current page on a website, type of network that the proxy access device 1220 is connected to, quantity of data received, quantity of data transmitted, latency to the destination device 1214, data throughput, received signal strength, transmit power, cost associated with data transfer on the second network 1212(2), and so forth. In some cases, log data collected by the server(s) 602 may also include or may be used to determine test data 604. The data collected by the server(s) 602 may therefore represent the AUT 1026 operating on a real-world second network 1212(2) at a desired geolocation, such as the second geolocation 1210. The log data, test data 604, or other data indicative of operation of the AUT 1026 may be used to generate an interface 902 indicative of characteristics of input received by, or output presented by, a device executing the AUT 1026.

In some implementations, instead of, or in addition to data determined by the server(s) 602, one or more deployed devices 1224 may provide test data 604 or other log data to the server(s) 602. Deployed devices 1224 may include, but are not limited to, any of the types of computing devices described with regard to the TD 1202. For example, a deployed device 1224 may execute the AUT 1026 and generate AUT traffic 1216, log data, test data 604 and so forth. In some implementations, the deployed device 1224 may be placed in an enclosure 102(3) with one or more other devices to enable the deployed device 1224 to present an output detectable by other device(s) or receive input indicative of an output presented by the other device(s).

Data determined by operation of the test device 1202, workstation 1206, proxy access devices 1220, and deployed devices 1224 may be used to generate interfaces 902, reports, determine modifications to the AUT 1026, and so forth. In some cases, while the AUT 1026 is executing on the proxy access devices 1220, one or more of the proxy access devices 1220 or the proxy host devices 1218 may display or store proprietary information. For example, it may be desirable to prevent individuals located at the second geolocation 1210 from viewing displays associated with the proxy access devices 1220, accessing data stored on the proxy access devices 1220 or proxy host devices 1218, or tampering with the devices themselves. Placement of the devices in an enclosure 102(2) may limit access to the devices. In some implementations, if an unauthorized access is determined, such as by determining sound, light, or vibrations associated with the enclosure 102(2) that exceed a threshold amount, one or more devices may be locked or deactivated, or data may be deleted from the device(s). Privacy of data associated with an AUT 1026 may be preserved by transmitting the data to a device maintained in a secure enclosure 102. In other cases, a secure test device 1202, workstation 1206, or deployed device 1224 may preserve the privacy of the data. For example, an SDK that is incorporated within a device may be used to determine test data 604 and other data regarding execution of an AUT 1026 without providing access to the data associated with the AUT 1026 to other devices.

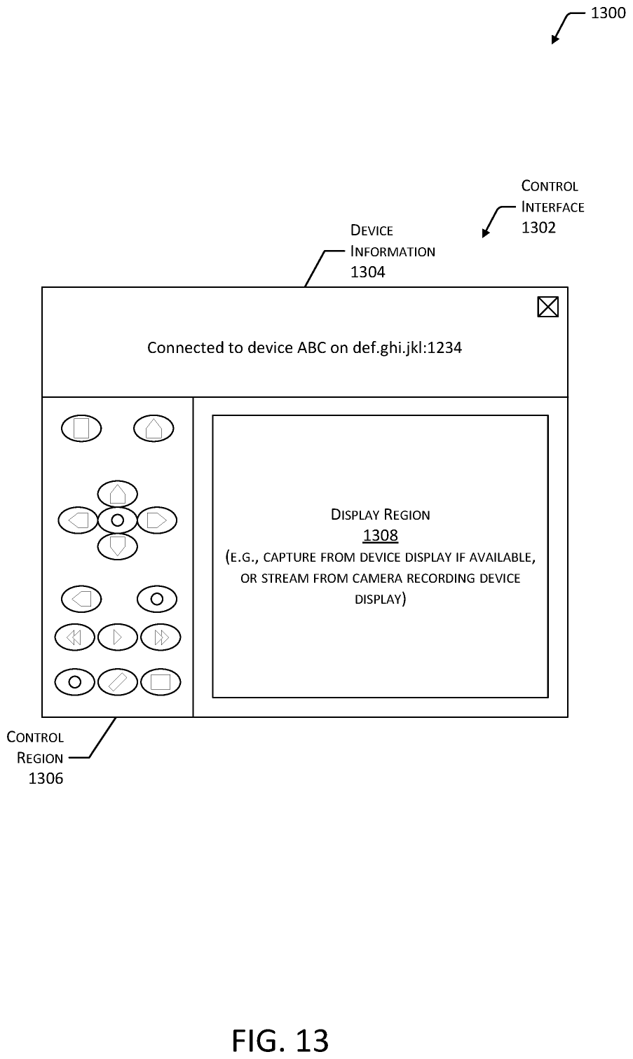

In some implementations, a workstation 1206 or other computing device 1002 may be used to access one or more devices in an enclosure 102, such as to provide input or receive output from the device(s). For example, FIG. 13 is a diagram 1300 depicting an implementation of a control interface 1302 that may be accessed by a user to provide input to devices in an enclosure and receive output from the devices. A user may provide input to a user interface selecting a device for access. The control interface 1302 may present device information 1304 indicative of the accessed device. For example, the device information 1304 may include a device name, an indication of a device type or other components of the device, an indication of one or more networks or ports or other characteristics of communication with the device, and so forth.

The control interface 1302 may also include a control region 1306 that may be used to provide input to the accessed device. For example, FIG. 13 depicts the control region 1306 including a series of buttons or other types of controls that may be used to provide commands to a device, navigate content presented by the device, and so forth. For example, buttons in the control region 1306 may include arrow buttons and selector buttons for navigating menus presented by a device, buttons corresponding to commands to cause a device to present content and control the presented content, and so forth. In some implementations, the control region 1306 may include a control that may be actuated to enable a user to provide audio input to the device. For example, the user may provide a voice command to a microphone of a workstation 1206 or other computing device 1002, and audio data indicative of the voice command may be provided to a device within the enclosure 102. In some cases, the audio provided to the device in the enclosure 102 may be used to control the device. In other cases, the audio provided to the device in the enclosure 102 may be output using one or more speakers, and a device in the enclosure 102 may receive the audio using a microphone. In some implementations, the control region 1306 may also include a control the may be actuated to enable a user to hear audio that is received by a microphone of a device in the enclosure 102.

The control interface 1302 may additionally include a display region 1308 that may present visible content associated with one or more devices in the enclosure 102. In some cases, the content presented in the display region 1308 may include content that is presented on a display 204 of a device. For example, screen capture functions or streaming of data may be used to transmit data from a device in an enclosure 102 to a workstation 1206 or other computing device 1002, which may then present at least a portion of the content that is presented on the display 204 of a device in the enclosure 102. In other cases, a device may not be usable to capture or transmit data indicative of a display output 504. In such a case, another device in the enclosure 102 may acquire data indicative of the display output 504 using a camera 202, and the display region 1308 may present at least a portion of the content that is acquired using the camera 202 of the device.

Using the control interface 1302, a user may provide commands to a device in an enclosure 102, such as through actuation of buttons or other controls in the control region 1306, including audio commands in some implementations. A user may then view a display output 504 in the display region 1308 that is presented in response to the commands, whether the display output 504 is acquired from the device presenting the output or a device that acquires data indicative of the output using a camera 202. In some implementations, a user may also access audio that is acquired using a microphone of one or more devices in the enclosure 102.

The processes discussed in this disclosure may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described in this disclosure. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMS), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
an enclosure;
a first device within the enclosure, wherein the first device includes a first display;
a second device within the enclosure, wherein the second device includes a first camera and at least a portion of the first display of the first device is positioned within a first field of view of the first camera;
one or more memories storing computer-executable instructions; and
one or more hardware processors to execute the computer-executable instructions to:
cause the first device to present a first output a using the first display, wherein the first output is based on first input data provided to the first device;
determine, from the first device, first data indicative of at least a first portion of the first output presented using the first display;
cause the second device to acquire second data indicative of at least a second portion of the first output using the first camera;
determine, from the second device, at least a portion of second data; and
generate an interface that presents a first indication of the first input data in association with a second indication of one or more of the first data or the at least a portion of the second data.

2. The system of claim 1, wherein the first device further includes a speaker and the second device further includes a microphone, the system further comprising computer-executable instructions to:
cause the first device to present a second output using the speaker, wherein the second output is based on one or more of the first input data or second input data provided to the first device;
determine, from the first device, third data indicative of at least a first portion of the second output presented using the speaker;
cause the second device to acquire fourth data indicative of at least a second portion of the second output using the microphone;
determine, from the second device, at least a portion of the fourth data; and
include, in the interface, a third indication of one or more of the third data or the at least a portion of the fourth data.

3. The system of claim 1, wherein the first device and the first camera are positioned on a first side of the second device and the second device further comprises a second camera on a second side of the second device, the system further comprising:
a third device within the enclosure and positioned on the second side of the second device, wherein the third device has a second display and at least a portion of the second display is within a second field of view of the second camera; and
computer-executable instructions to:
cause the third device to present a second output using the second display, wherein the second output is based on one or more of the first input data or second input data provided to the third device;
determine, from the third device, third data indicative of at least a first portion of the second output presented using the second display;
cause the second device to acquire fourth data indicative of at least a second portion of the second output using the second camera;
determine, from the second device, at least a portion of the fourth data; and
include, in the interface, a third indication of one or more of the third data or the at least a portion of the fourth data.

4. The system of claim 1, wherein the second device and the first camera are positioned on a first side of the first device, the system further comprising:
a third device within the enclosure and positioned on a second side of the first device, wherein the third device has a second camera and at least a portion of the first device is within a second field of view of the second camera; and
computer-executable instructions to:
cause the third device to acquire third data using the second camera, wherein the third data is indicative of one or more features of the at least a portion of the first device;
determine, from the third device, at least a portion of the third data; and
include, in the interface, a third indication of the at least a portion of the third data.

5. The system of claim 1, wherein at least one of the first device or the second device is movable toward and away from the other of the first device or the second device to change the at least a portion of the first display within the first field of view of the first camera.

6. The system of claim 1, further comprising computer-executable instructions to:
present, using a device outside of the enclosure, a first display output based on one or more of: at least a portion of the first data or at least a portion of the second data;
receive input from the device outside of the enclosure;
provide data indicative of the input to the first device, wherein the first device presents a second output using the first display based on the input; and
present, using the device outside of the disclosure, a second display output based on the second output.

7. The system of claim 1, wherein the first device includes a set top box device in communication with the first display, the system further comprising:
a third device within the enclosure and in communication with the first device; and
computer-executable instructions to:
cause the third device to provide a command to the first device, wherein the command causes the first device to present the first output using the first display.

8. A system comprising:
an enclosure;
a first device within the enclosure, wherein the first device includes a first speaker;
a second device within the enclosure, wherein the second device includes a first microphone;
one or more memories storing computer-executable instructions; and
one or more hardware processors to execute the computer-executable instructions to:
cause the first device to present a first output using the first speaker, wherein the first output is based on first input data provided to the first device;
determine, from the first device, first data indicative of at least a first portion of the first output presented using the first speaker;
cause the second device to acquire second data indicative of at least a second portion of the first output using the first microphone;
determine, from the second device, at least a portion of the second data; and
generate an interface that presents a first indication of the first input data in association with a second indication of one or more of the first data or the at least a portion of the second data.

9. The system of claim 8, further comprising:
a third device within the enclosure, wherein the third device includes a second speaker; and
computer-executable instructions to:
cause the third device to present a second output using the second speaker, wherein the second output is based on one or more of the first input data or second input data provided to the third device;
determine, from the third device, third data indicative of at least a first portion of the second output presented using the second speaker;
cause the second device to acquire fourth data indicative of at least a second portion of the second output using the first microphone;
determine, from the second device, at least a portion of the fourth data; and
include, in the interface, a third indication of one or more of the third data or the at least a portion of the fourth data.

10. The system of claim 8, further comprising:
a third device within the enclosure, wherein the third device includes a second microphone; and
computer-executable instructions to:
cause the third device to acquire third data indicative of the at least a third portion of the first output using the second microphone;
determine, from the third device at least a portion of the third data; and
include, in the interface, a third indication of the at least a portion of the third data.

11. The system of claim 8, further comprising:
a camera associated with one of the first device or the second device, wherein the other of the first device or the second device is positioned within a field of view of the camera; and
computer-executable instructions to:
cause the one of the first device or the second device to acquire third data using the camera, wherein the third data is indicative of one or more features of at least a portion of the other of the first device or the second device;
determine at least a portion of the third data from the one of the first device or the second device; and
include, in the interface, a third indication of the at least a portion of the third data.

12. The system of claim 8, wherein one or more of the first device or the second device includes one or more of: a smartphone, a tablet computer, a television, or a networked speaker device.

13. The system of claim 8, wherein the first device comprises a networked speaker device that includes a second microphone, the system further comprising computer-executable instructions to:
cause an audio input based on the first input data to be provided to the first device; and
cause the first device to acquire third data indicative of at least a portion of the audio input using the second microphone, wherein the first device determines the first output based on the at least a portion of the audio input.

14. A system comprising:
an enclosure;
a first device within the enclosure, wherein the first device includes one or more of: a first speaker, a first microphone, a first display, or a first camera;
one or more memories storing computer-executable instructions; and
one or more hardware processors to execute the computer-executable instructions to:
cause the first device to present a first output based on first input data provided to of the first device;
determine, from the first device, first data indicative of at least a first portion of the first output;
acquire second data indicative of at least a second portion of the first output; and
generate an interface that presents a first indication of the first input data in association with a second indication of one or more of the first data or the second data.

15. The system of claim 14, further comprising computer-executable instructions to:
determine third data using one or more of:
the first camera,
the first microphone,
a light sensor within the enclosure, or
a second microphone in the enclosure;
wherein the third data is indicative of a first amount of one or more of: light or sound within the enclosure; and
determine that the first amount is less than a threshold amount;
wherein the first device is caused to present the first output in response to the first amount being less than the threshold amount.

16. The system of claim 14, further comprising computer-executable instructions to:
determine, using one or more of: the first camera, the first microphone, a light sensor within the enclosure, a second microphone in the enclosure, or a vibration sensor within the enclosure, third data indicative of one or more of:
an amount of light within the enclosure that is greater than a threshold amount of light;
an amount of sound within the enclosure that is greater than a threshold amount of sound; or
an amount of vibration associated with the enclosure that is greater than a threshold amount of vibration; and
generate a notification indicative of at least a portion of the third data.

17. The system of claim 14, further comprising:
a mount that engages the first device with a surface of the enclosure, wherein the mount is movable relative to the surface of the enclosure to position the first device within the enclosure.

18. The system of claim 14, further comprising:
a second device within the enclosure, wherein the second device includes one or more of a second speaker, a second microphone, a second display, or a second camera; and
computer-executable instructions to:
determine, based on the first data, one or more features of the first output to prevent recording of the first output using the first device;
wherein the second device is caused to acquire at least a portion of the second data in response to determining the one or more features of the first output.

19. The system of claim 14, further comprising computer-executable instructions to:
determine a first time associated with providing the first input data to the first device;
determine a second time associated with presentation of the first output using the first device; and
include, in the interface, a third indication of the first time and a fourth indication of the second time.

20. The system of claim 14, further comprising:
a reflective surface positioned within a field of view of the first camera;
wherein the first output is presented using the first display, the reflective surface reflects at least a portion of the first output toward the first camera, and the second data is determined using the first camera.
